(19) United States
(12) Patent Application Publication
(10) Pub. No.: US 2015/0336676 A1
(43) Pub. Date: Nov. 26, 2015

(54) AIRFOIL ICING CONTROLLER APPARATUSES, METHODS AND SYSTEMS

(71) Applicant: TELVENT DTN LLC, Omaha, NE (US)

(72) Inventors: Donald MCCANN, Overland Park, KS (US); James H. BLOCK, Minneapolis, MN (US); Daniel W. LENNARTSON, Burnsville, MN (US)

(73) Assignee: Telvent DTN LLC, Omaha, NE (US)

(21) Appl. No.: 14/758,774

(22) PCT Filed: Dec. 31, 2013
(86) PCT No.: PCT/US13/78541

§ 371 Date: Jun. 30, 2015

(51) Int. Cl. B64D 15/20; G08G 5/00

(52) U.S. Cl. CPC B64D 15/20; G08G 5/0034; G08G 5/0091

(57) ABSTRACT

The AIRFOIL ICING CONTROLLER APPARATUSES, METHODS AND SYSTEMS (“AIC”) transforms weather and flight parameter data via AIC components into icing determinations and icing avoidance optimized flight plans based on airfoil type. In one implementation, the AIC comprises a processor and a memory disposed in communication with the processor and storing processor-issuable instructions to receive anticipated flight plan parameter data, obtain weather data based on the flight plan parameter data, obtain atmospheric data based on the flight plan parameter data, and determine a plurality of four-dimensional grid points based on the flight plan parameter data. The AIC may then determine a percent power increase (PPI) required by the aircraft to overcome power loss due to icing conditions. With dynamic, (near) real-time icing information and/or predictive icing forecast specific to airfoil type, the AIC may allow aircraft to efficiently avoid areas where PPI is greater than a predetermined percentage and/or avoid areas where dangerous icing may occur.

### PRIORITY CLAIM

This application is a non-provisional of and claims priority under 35 U.S.C. §119 to: U.S. provisional patent application Ser. No. 61/747,899, filed Dec. 31, 2012, entitled “Airfoil Icing Platform Apparatuses, Methods and Systems,” attorney docket no. SCHN-006/00US 318573-2006; U.S. provisional patent application Ser. No. 61/773,726, filed Mar. 6, 2013, entitled “Airfoil Icing Platform Apparatuses, Methods and Systems,” attorney docket no. SCHN-006/01US 318573-2011; and U.S. provisional patent application Ser. No. 61/748,046, filed Dec. 31, 2012, entitled “Dynamic Airfoil Platform Manager Apparatuses, Methods and Systems,” attorney docket no. SCHN-007/00US 318573-2010. The entire contents of the aforementioned applications are expressly incorporated by reference herein.

This application for letters patent document discloses and describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### BACKGROUND

A variety of weather monitoring systems, including ground-based and satellite-based observations, are used to provide weather reports and forecasts, including icing conditions.

### BRIEF DESCRIPTION OF THE DRAWINGS

The accompanying appendices and/or drawings illustrate various non-limiting, example, inventive aspects in accordance with the present disclosure:

FIG. 1 provides an overview of an aspect of the AIC;

FIG. 2 shows a data flow diagram illustrating an example of a AIC accepting inputs and data requests, utilizing internal data repositories for data request execution and outputting both predictive and (near) real-time data in some embodiments of the AIC;

FIG. 3 shows a data flow diagram illustrating an example of an AIC initializing internal data repositories for input while accepting inputs and data requests and outputting both predictive and (near) real-time data in some embodiments of the AIC;

FIG. 4 demonstrates a logic flow diagram illustrating example AIC data requests, creating an aircraft profile, accepting input and outputting grid point percent power increase (PPI) in some embodiments of the AIC;

FIG. 5 demonstrates a logic flow diagram illustrating example AIC data requests, accessing an aircraft profile, accepting input and outputting grid point percent power increase (PPI) in some embodiments of the AIC;

FIG. 6 demonstrates an example user interface where icing prediction is integrated into an existing and/or future flight planning tool, allowing users to alter flight path creation to account for projected icing in some embodiments of the AIC;

FIG. 6A shows a logic flow diagram illustrating an example of an AIC integrating icing modeling into flight path creation, facilitating user preference in flight planning variation in some embodiments of the AIC;

FIGS. 7-11 show various example and/or visual input/output component aspects of the AIC;

FIG. 12 illustrates aspects of ice accumulation and resultant PPI values with respect to a Beechcraft King Air airfoil, in one implementation of the AIC;

FIG. 13 illustrates aspects of ice accumulation and resultant PPI values with respect to a Boeing 737 airfoil, in one implementation of the AIC;

FIG. 14 shows an example percent power increase (“PPI”) component installation and usage scenario, in one implementation of the AIC;

FIGS. 15A-F show an example PPI component hardware component, in one implementation of the AIC; and

FIG. 16 shows a block diagram illustrating embodiments of a AIC controller;

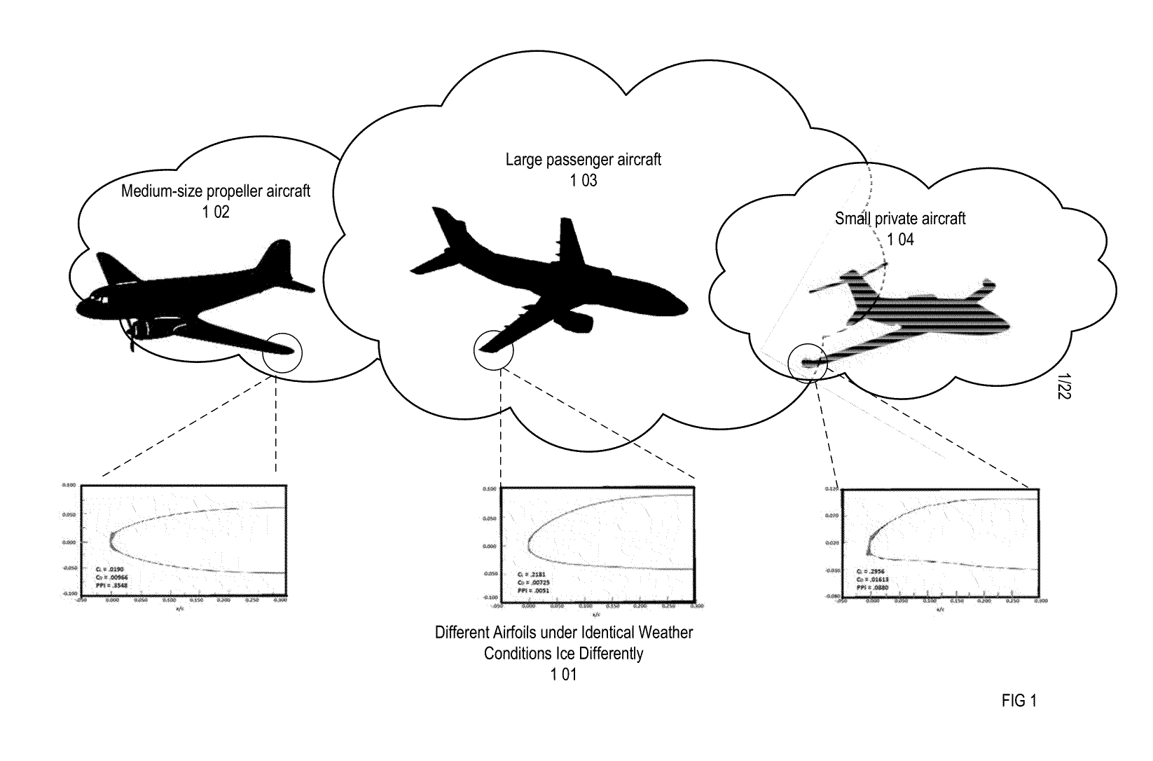

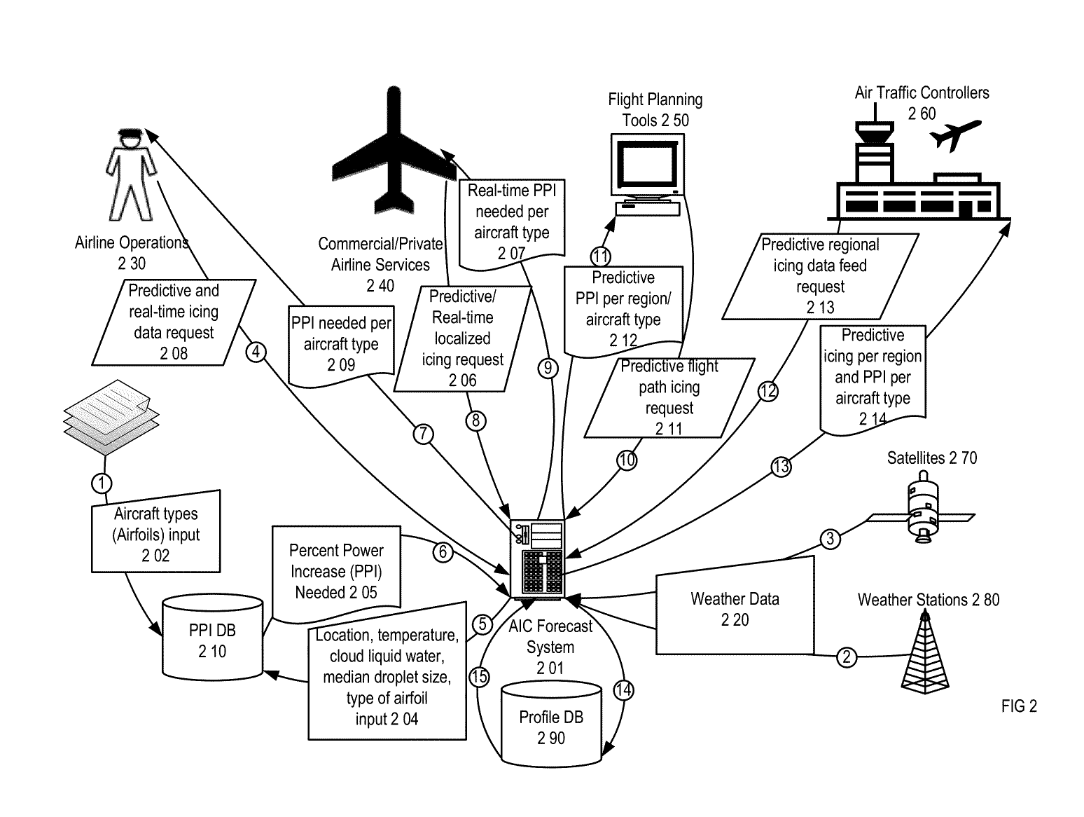

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Airfoil Icing Controller (AIC)

In some embodiments, the AIRFOIL ICING CONTROLLER (“AIC”) as disclosed herein transforms weather and flight parameter data via AIC components into icing avoidance optimized flight plans based on airfoil type. In one implementation, the AIC comprises a processor and a memory disposed in communication with the processor and storing processor-issuable instructions to receive anticipated flight plan parameter data, obtain weather data based on the flight plan parameter data, obtain atmospheric data based on the flight plan parameter data, and determine a plurality of four-dimensional grid points based on the flight plan parameter data. The AIC may then determine a percent power increase (PPI) required by the aircraft to overcome power loss due to icing conditions. With (near) real-time icing information and/or predictive icing forecast specific to airfoil type, the AIC may allow aircraft to avoid areas where PPI is greater than a predetermined percentage and/or avoid areas where icing may occur.

Icing forecasting methods may focus on general categories of aircraft, such as aircraft size, and real-time icing information rely primarily on pilot reports (PIREPS), other subjective/observational data, and local sensors for determining icing airspace regions. In one embodiment, an array of sensors both local and remote may be periodically polled by an aircraft itself, directly by the AIC, and/or the like. The polled array of sensors may include, for example, sensors for measuring altitude, heading, speed, pitch, temperature, barometric pressure, the water content of the atmosphere and/or clouds, fuel consumption, fuel remaining for flight, number of passengers, aircraft weight, and/or the like. The AIC as disclosed herein utilizes unique predictive determination components of icing per unique airfoil type and utilizes these predictive components to generate a comprehensive forecasting map display and/or overlay that is not merely a generalized icing projection for aircraft of a broad-spectrum type, but is the specification of icing to any airfoil known to the AIC, providing an accurate, model of icing over a specified spatial/temporal area.

Icing determination may rely on sensors located on an aircraft to determine when icing has occurred. This method fails to give advance warning aircraft personnel to potential icing hazards and may not give sufficient notice for course correction to improve icing conditions. In some scenarios, an aircraft advancing into icing conditions may lose altitude and/or be forced to terminate a specific flight plan without adequate notification of impending icing conditions. Icing forecasts may rely on weather conditions alone to determine if icing may occur and may apply only a generalized aircraft type to forecasting methods, an example of which might be that a small aircraft may experience more significant icing than a larger aircraft or require a greater power increase in icing conditions. However, airfoils, generally defined as curved surface structures that provide aircraft with positive lift to drag ratios, under identical weather conditions may ice differently, without respective to other aspects of aircraft construction and/or size 101. In one example, a medium size propeller plane 102 may form ice encasing the endpoint of its airfoil requiring a PPI of 0.3548. In this example under duplicate weather conditions, a large passenger aircraft 103 may experience only slight icing of its airfoil, requiring a much smaller PPI of 0.0051. Lastly, in this example, under these replicated weather conditions, a small private aircraft 104 may experience larger ice formation on its airfoils than the passenger aircraft and require a PPI of 0.0880, which is greater than that of the passenger aircraft, but less than that of the medium-sized propeller aircraft. By way of example, the terms “small”, “medium”, and “large” have been employed to describe diverse aircraft generalized in FIG. 1. The AIC, however, may be indeterminate of aircraft size, purpose, and/or the like. In this embodiment, the AIC uses airfoil type to determine how, where, under what conditions, and/or the like of icing occurrence. In some embodiments, the AIC may associate aircraft with their known airfoil types. In some embodiments, the AIC may maintain information exclusive to airfoils. In some embodiments, the AIC may use aircraft type reciprocally with airfoil type.

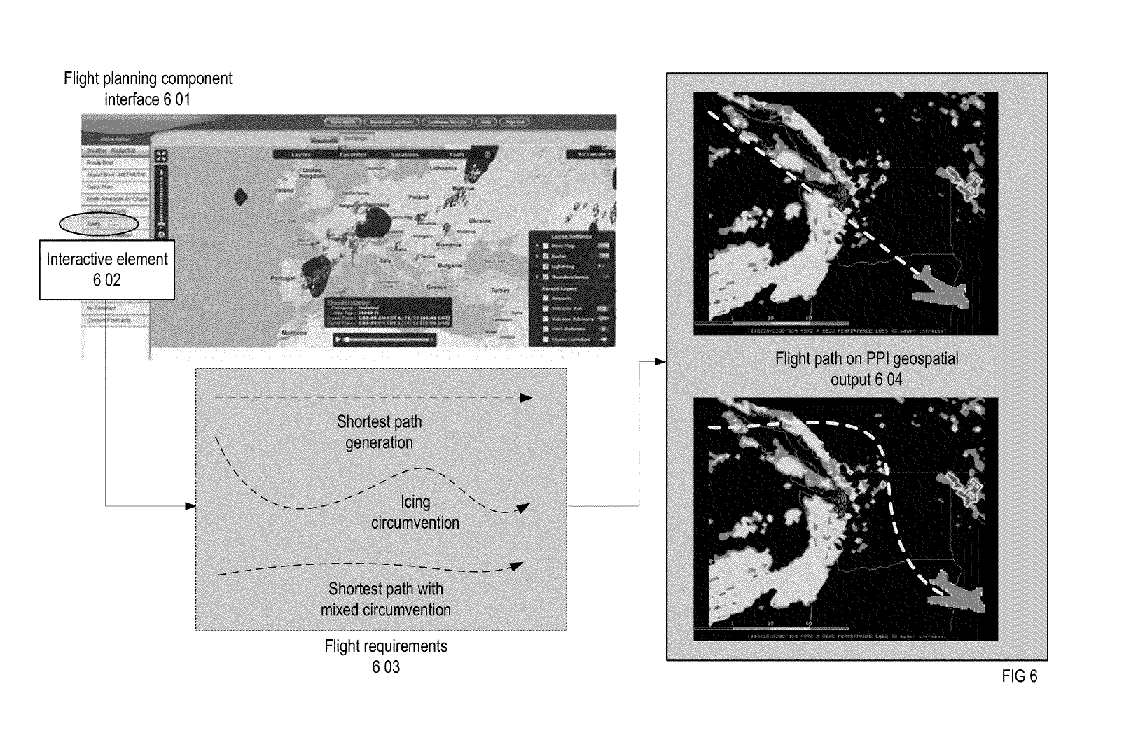

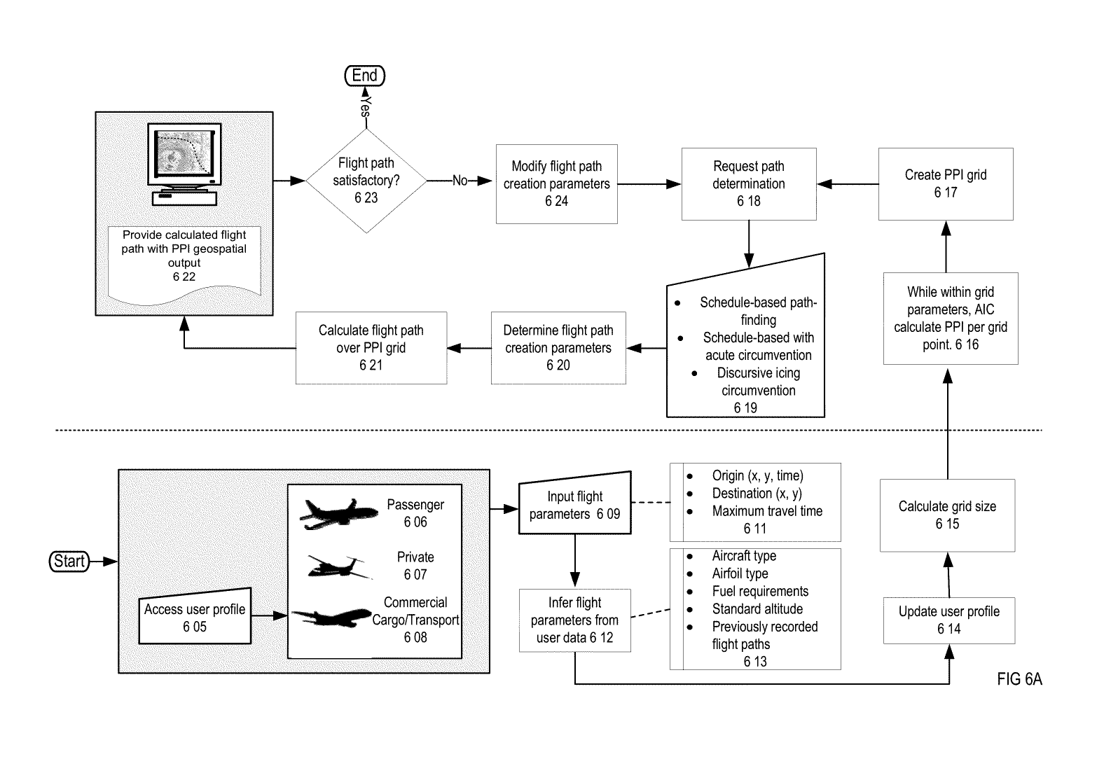

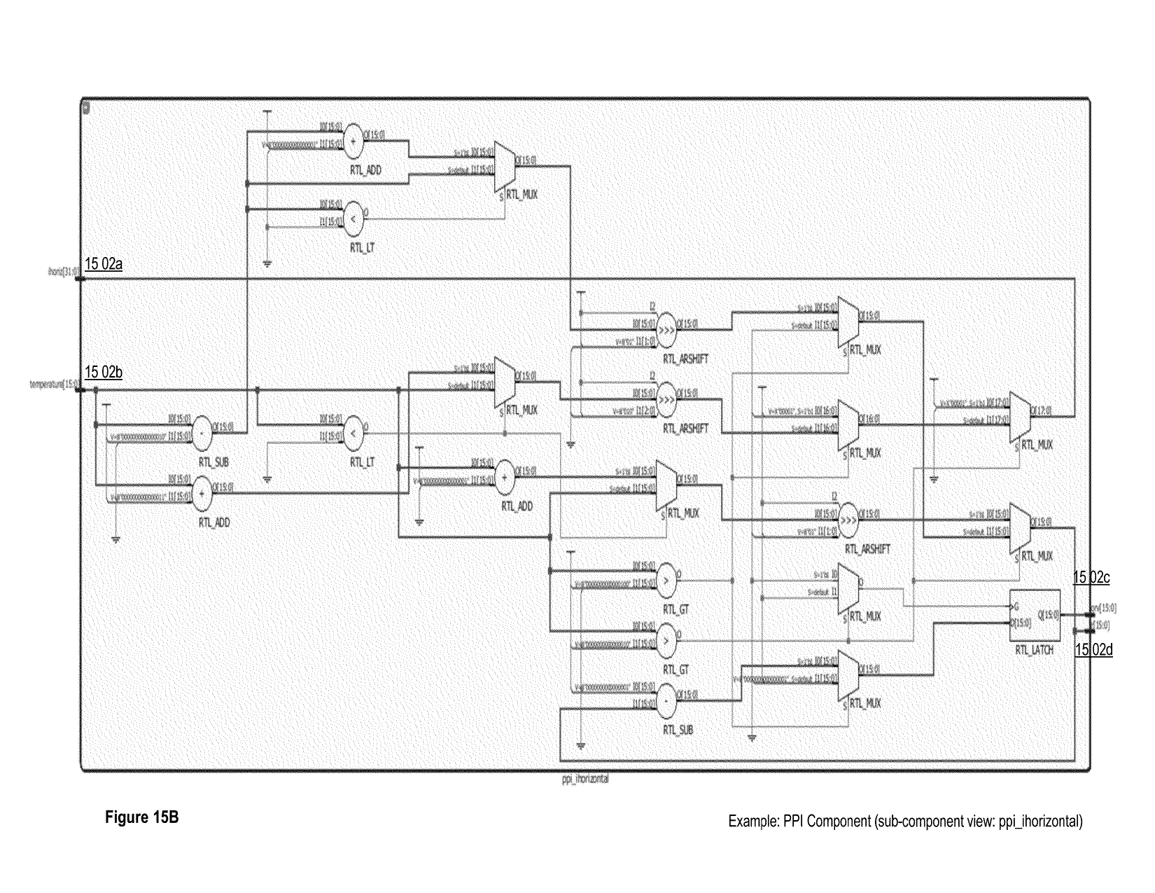

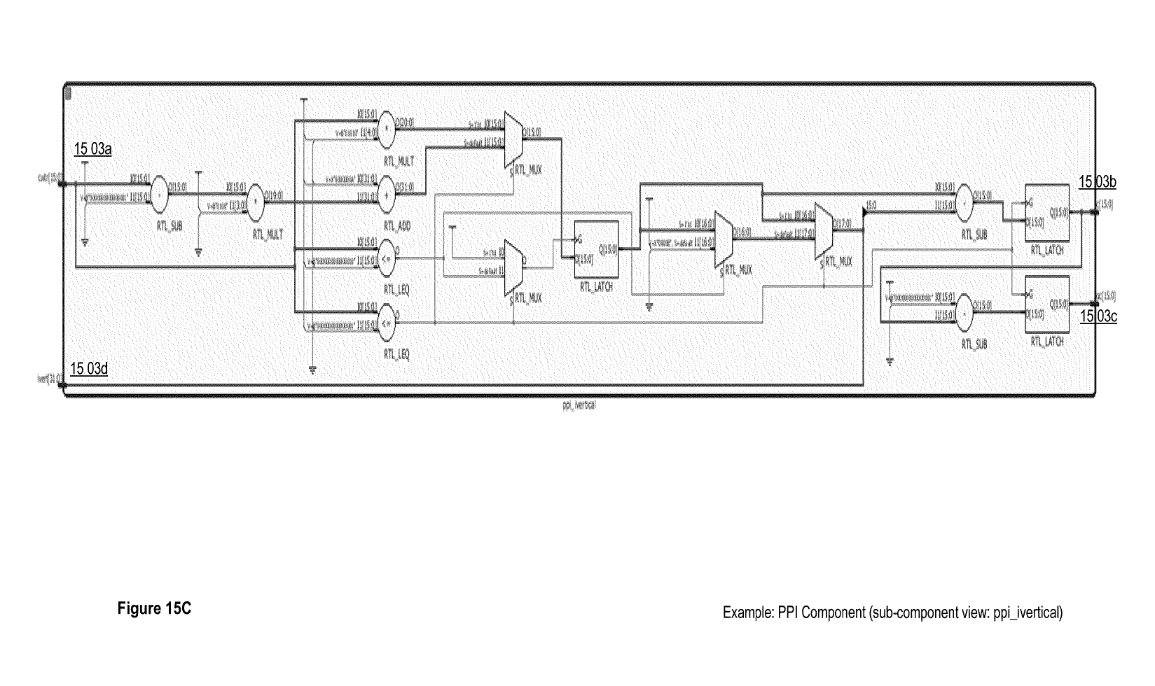

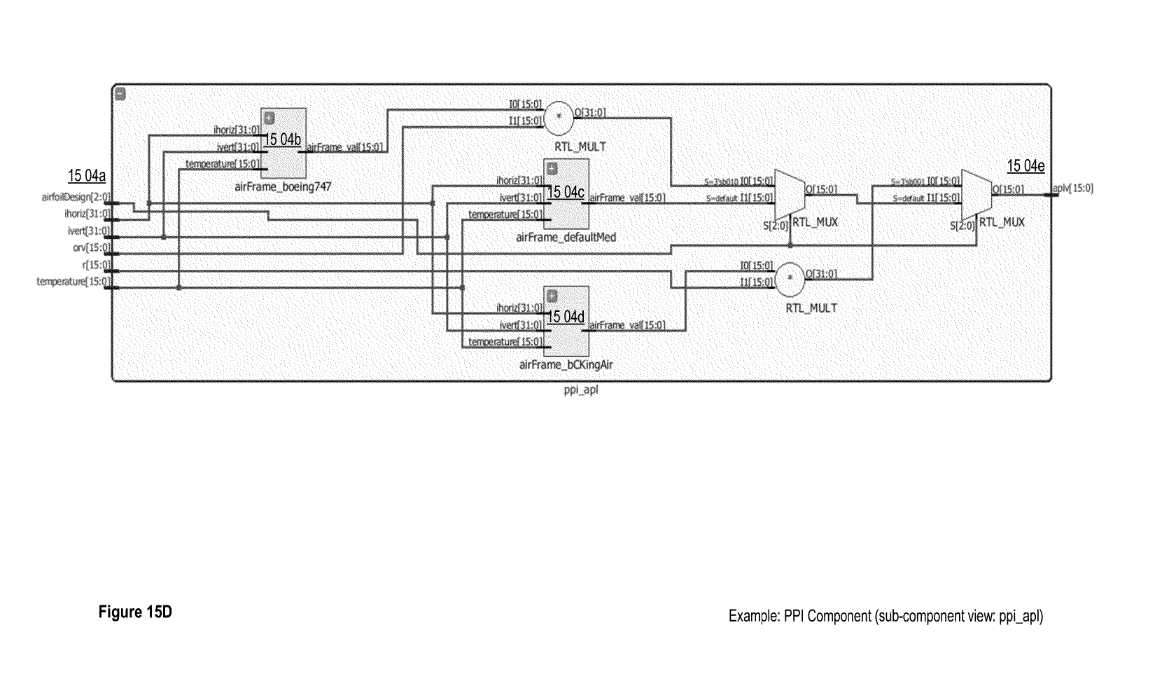

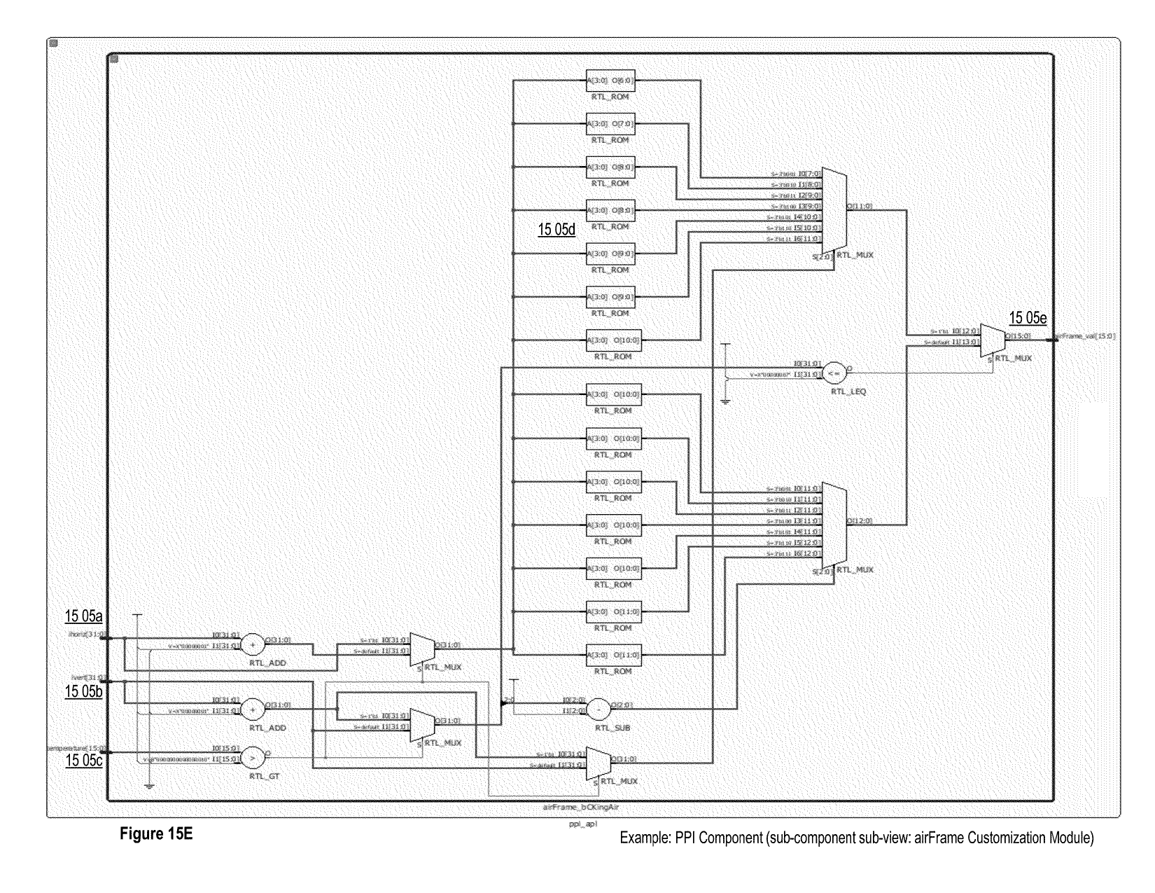

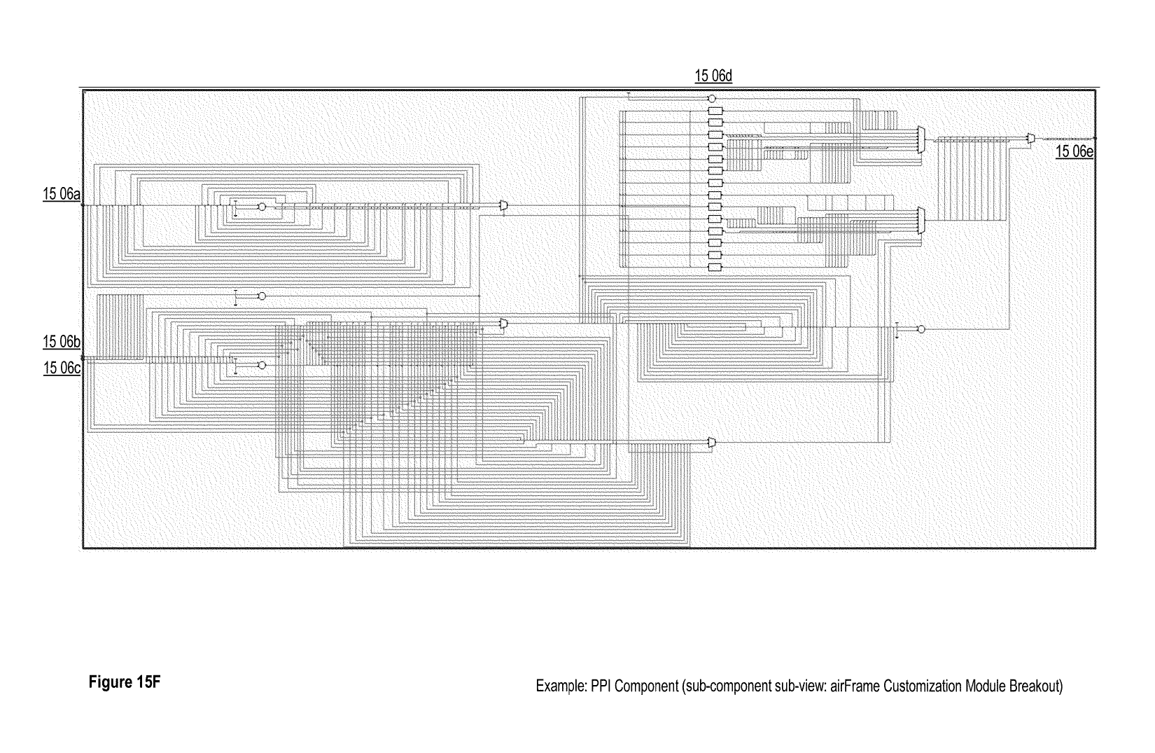

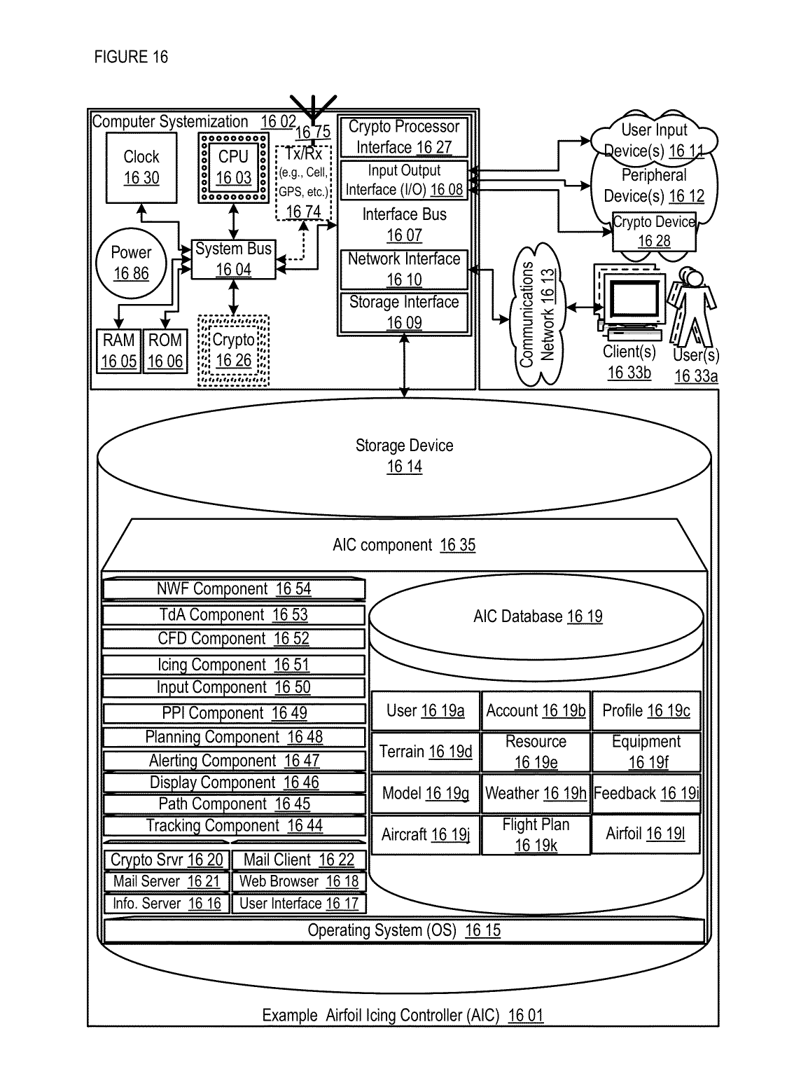

In some embodiments of the disclosure, the AIC 201 may maintain a data repository 210 of aircraft PPI. In some embodiments, the data repository may be organized by aircraft type. In some embodiments, the data repository may be organized by airfoil type. In some embodiments, data tables of aircraft and airfoil types may be linked by information keys, associating aircraft and airfoil types. In other embodiments, the aircraft and/or airfoil parameters for use by the AIC may be stored with respect to a PPI module, such as that disclosed with respect to FIG. 16 (e.g., PPI Component 1649; AIC data store 1619, Weather 1619h, Aircraft 1619i, Airfoil 16191; and/or the like); FIGS. 15A-F (e.g., an example PPI hardware module); and/or the like. The PPI component and/or data repository may be internally searchable to the AIC by a database query language and/or platform. In some embodiments, the AIC may allow external sources to query the data repository. In this embodiment, aircraft types are independently input 202 to the PPI data repository, which is maintained internally to the AIC. Weather data and/or modeling such as the Global Forecasting System (GFS) and Rapid Refresh (RAP) may be made available to the AIC through satellite transmission 270, weather station input 280, and/or the like. In some embodiments, the AIC may reduce weather data to determinate icing factors. In some embodiments, the AIC may request specific numerical weather input that is icing condition related. In some embodiments of the AIC, weather input is continuous and/or updated at systematic intervals. In the example of FIG. 2, airline operations 230 may request both predictive and (near) real-time icing data 208 from the AIC. In this example, the operational request contains the aircraft type(s) for which icing conditions should be predicted. In some embodiments, the AIC may contain user profile information under which a user, having created a profile with the AIC, may provide identifying information other than aircraft type. In some embodiments, the AIC may store user information in a profile data repository 290 and access aircraft type(s) and/or other user information based on identifying input data. The AIC may then submit operational data, such as airfoil type and location, localized and real-time weather data, such as temperature, cloud liquid water, and median droplet size, and/or the like 204 to the PPI data repository 210 which may then return PPI(s) 205 needed for requested aircraft and/or conditions. The AIC may return 209 this output to the airline operations as requested. In one example, commercial and/or private airline services 240 may request predictive and/or (near) real-time localized icing information. In some embodiments, this request may contain aircraft type and other user information. In some embodiments, this request may contain identifying information to access user profile data stored in a AIC profile data repository. The AIC may submit the relevant operational and weather data to the PPI data repository and receive PPI(s) as described, returning output to the requestor 240. In some embodiments, in-house and/or third party flight planning tools 250 may request 211 predictive icing conditions over a region for one or more aircraft types. In some embodiments, the flight planning tools may have and/or share user profile information of a profile data repository with the AIC in making this request. In some embodiments, the AIC may return a PPI grid overlay for the requested region 212. In some embodiments, the AIC may return a flight path over PPI grid overlay for the requested region, according to flight path request parameters, as described in FIGS. 6-6A. In some embodiments, the AIC may return multiple paths and/or PPI grid overlays for the requested regions. In another example, air traffic controllers 260 may request predictive localized icing data 213 for its common regional aircraft from the AIC. As in other examples, this request may provide all necessary input data singly and/or with identifying information with which the AIC may access stored profile information from a profile data repository. The AIC may submit the necessary inputs and return a regional icing grid overlay 214 and/or PPI(s) for all aircraft type which may have been named in the data request or which may be part of an accessed profile. In some embodiments, the AIC may use request data to maintain and/or update a profile data repository to assist in future data requests from sources for which a profile has been created. In some embodiments, the AIC may use request data to create user profile data for sources for which no profile data previously existed.

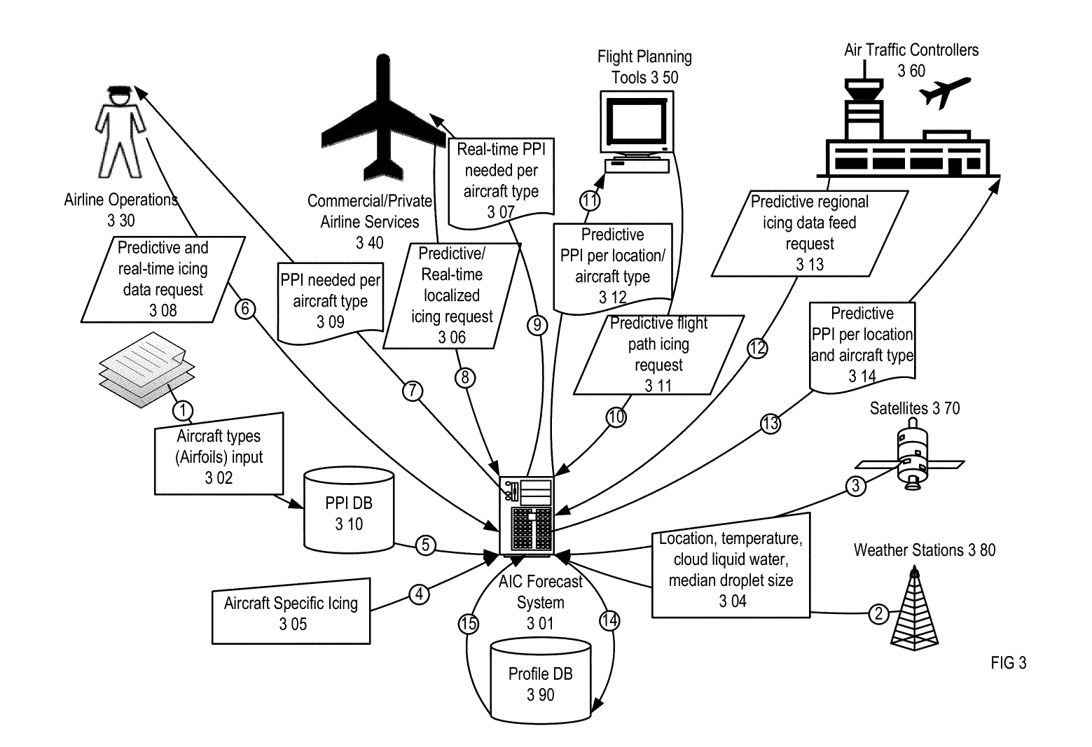

FIG. 3 shows an alternate embodiment of AIC data flow in which data requests are received from like sources 330, 340, 350, 360, such as in FIG. 2 and which aircraft/airfoil type 302, aircraft specific icing 305, location/region, weather data such as temperature, cloud liquid water, median droplet size 304, and/or the like is input to the AIC. In this embodiment, a PPI data repository 310 may store aircraft/airfoil type in the manner(s) described in FIG. 2, and may be used as an input source to the AIC. In this embodiment, data requests such as 306 308 311 313 are fulfilled through the AIC, with data requests providing either input singly and/or with identifying user information to access profile data from a profile repository 390, as may be maintained by the AIC as described in FIG. 2. In some embodiments of the disclosure, the data repositories storing PPI, aircraft/airfoil type, and/or user profile information may be separate from, but accessible to, the AIC. As in FIG. 2, the AIC may provide similar outputs 307 309 312 314 to requesting parties. The AIC may maintain/update its profile data repository with information from processed requests.

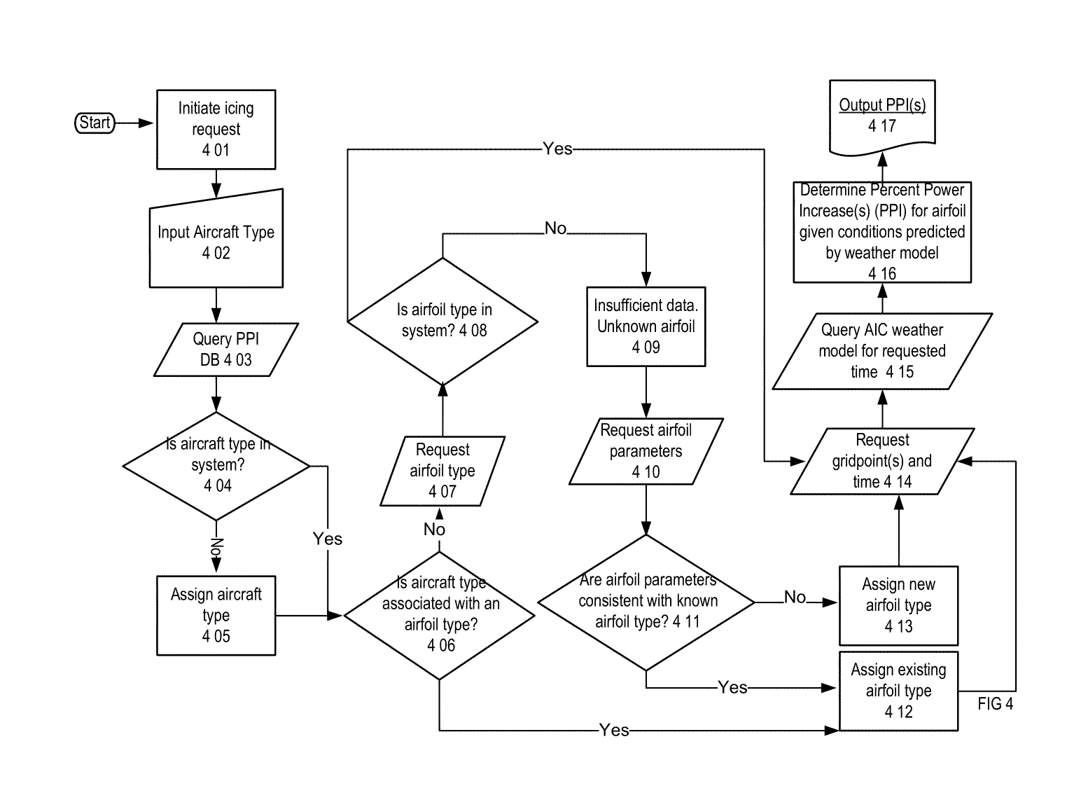

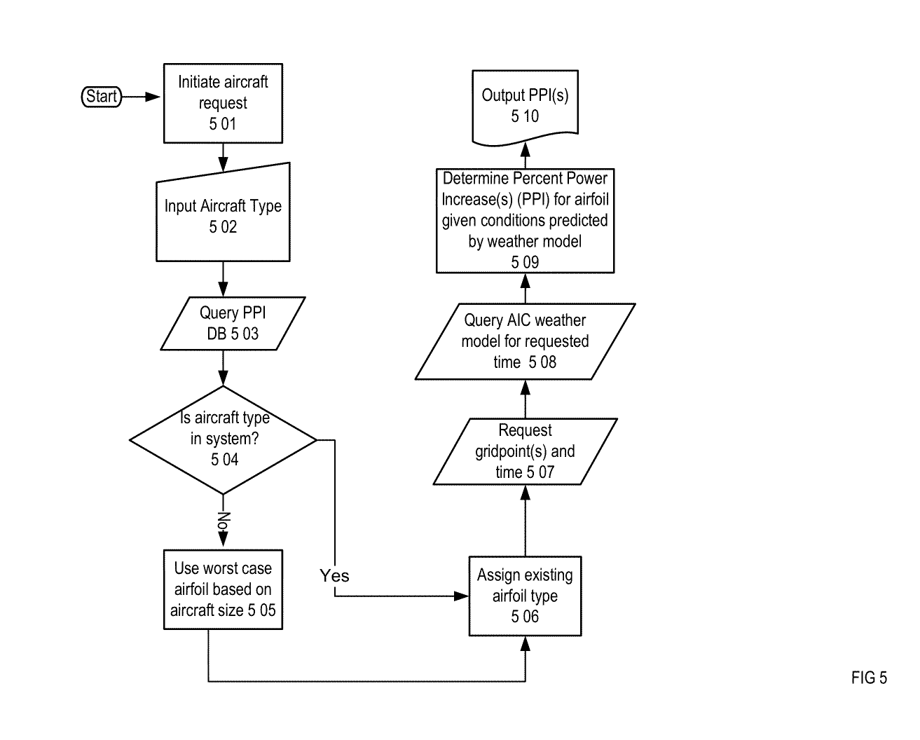

In FIG. 4, one embodiment of the AIC's PPI calculation component is put forth. In this embodiment, an icing request is initiated to the AIC 401. The AIC may request the aircraft type(s) 402. In some embodiments, the AIC may use provided identifying user information as part of a user profile maintained by the AIC to determine aircraft type(s). In this embodiment, the AIC maintains a PPI data repository, which may be internal or external to the AIC, of aircraft types and/or airfoil types which may be maintained in separate tables or repository with information keys linking types. In all subsequent aspects of the diagram, reference aircraft and/or airfoil may be singular or plural, i.e. the AIC may be considered to process multiple types in each request or the AIC may process a single type in a request. The AIC may query the PPI data repository 403 to determine if the aircraft type is already known to the system. If the aircraft type is not stored in the PPI 404, the AIC may assign an aircraft type 405 by creating a new or finding an existing matching record in the PPI that conforms to the aircraft specifications. If the aircraft is not associated with a known airfoil type 406, the AIC may request that an airfoil type be associated with the aircraft 407 and request an airfoil identification. If the airfoil type identified is not in system 408, the AIC may issue an insufficient data notice 409 and request the parameters of the airfoil type 410. If the input parameters of the airfoil match a known airfoil type, the input airfoil is recorded as the existing airfoil type 412. If the input parameters of the airfoil do not match an existing type, the AIC may create a new record in the PPI data repository with the input airfoil parameters 413. If the aircraft type is known and/or the airfoil type is known, and/or the AIC has input new aircraft/airfoil types in the PPI, the AIC may request gridpoints and time to calculate icing data 414. The AIC may execute a query on its icing component for the requested points and time 415. The AIC may then determine the PPI necessary for input aircraft under the defined conditions, as predicted by the AIC weather model. The following non-discursive PPI calculation/determination embodiment, presented substantially in the form of a Fortran code fragment, shows one embodiment of a methodology for such processing:

C
C* Get grid file user input.
C

WRITE ( 6, 1002 )
READ ( 5, 999 ) gdfile
WRITE ( 6, 1003 )
READ ( 5, 999 ) gdout
WRITE ( 6, 1004 )
READ ( 5, 999 ) fhour
WRITE ( 6, 1005 )
READ ( 5, 999 ) acft

C
C* Fill aircraft performance loss table depending on aircraft type.
C

IF ( acft .eq. ‘be20 ’ ) THEN

DO m = 1,14

DO n = 1,10

apltbl (m,n) = be20(m,n)

END DO

END DO

ELSE

DO m = 1,14

DO n = 1,10

apltbl (m,n) = be20(m,n)

END DO

END DO

END IF

C
C* Get grid file user input.
C

WRITE ( 6, 1002 )
READ ( 5, 999 ) gdfile
WRITE ( 6, 1003 )
READ ( 5, 999 ) gdout
WRITE ( 6, 1004 )
READ ( 5, 999 ) fhour
WRITE ( 6, 1005 )

C
C* Find levels in model.
C

CALL DG_GLEV ( 1, time, ivcord, LLMXLV,

+ iflev, nlev, iret )

DO j = 1, nlev

rlevel (j) = FLOAT ( iflev (1,j) )

END DO
CALL LV_SORT ( ivcord, nlev, rlevel, iret )

C

DO j = 1, nlev

CALL ST_INCH ( INT ( rlevel (j )), glevel, iret )

C
C* Read icing parameter grids.
C

gvcord = ‘HGHT’
gfunc = ‘TMPC’
CALL DG_GRID ( timfnd, glevel, gvcord, gfunc, pfunc, t,

+ igx, igy, time, level, ivcord, parm, iret )

gfunc = ‘CWTR’
CALL DG_GRID ( timfnd, glevel, gvcord, gfunc, pfunc,
cwtr,

+ igx, igy, time, level, ivcord, parm, iret )

gfunc = ‘MVD’
CALL DG_GRID ( timfnd, glevel, gvcord, gfunc, pfunc,
mvd,

+ igx, igy, time, level, ivcord, parm, iret )

maxpts = igx*igy

C
C* Compute aircraft performance loss.
C

DO i = 1, maxpts

IF ( t(i) .eq. RMISSD .or. cwtr(i) .eq. RMISSD )
THEN

apl(i) = RMISSD

ELSE IF ( (t(i) .ge. 0.0) .or. (t(i) .le. −40.0) .or.

+ (cwtr(i) .le. 0.0) ) THEN
apl(i) = 0.0

ELSE

C
C* Bi-linearly interpolate aircraft icing values.
C

IF ( cwtr(i) .le. .001 ) THEN

rcol = cwtr(i)/.0001
icol = rcol
c = rcol − FLOAT(icol)
oc = 1. − c

ELSE IF ( cwtr(i) .le. .002 ) THEN

rcol = 10. + (cwtr(i)− .001)/.00025
icol = rcol
c = rcol − FLOAT(icol)
oc = 1.0 − c

ELSE

icol = 14

END IF
IF ( t(i) .gt. −2.0 ) THEN

r = −t(i)/2.0
apl(i) = apltbl (1,icol)*r*oc +
apltbl(1,icol+1)*r*c

ELSE IF ( t(i) .gt. −4.0 ) THEN

irow = 1
r = (−t(i) − 2.0)/2.0
or = 1. − r
IF ( icol .eq. 14 ) THEN

apl(i) = apltbl(1,14)*or +
apltbl(2,14)*r

ELSE

apl(i) = apltbl(irow,icol)*oc*or

+ + apltbl(irow,icol+1)*c*or
+ + apltbl(irow+1,icol)*oc*r
+ + apltbl(irow+1,icol+1)*c*r

END IF

ELSE

rrow = (−t(i)/4.0) +1.0
irow = rrow
r = rrow − FLOAT (irow)
or = 1.0 − r
IF ( icol .eq. 14 ) THEN

apl(i) = apltbl(irow,14)*or + apltbl
(irow+1,14)*r

ELSE

apl(i) = apltbl(irow,icol)*oc*or

+ + apltbl(irow,icol+1)*c*or
+ + apltbl(irow+1,icol)*oc*r
+ + apltbl(irow+1,icol+1)*c*r

END IF

END IF

END IF

END DO

C
C* Output PPI
C

ifl(1) = INT(rlevel(j))
ifl(2) = −1
parm = ‘apl’
CALL DG_NWDT ( apl, time, ifl, ivcord, parm,ighdr,
+ gpack, .true., iret )
IF ( iret .eq. 0 ) write (6,*) time(1), parm, ‘ at ’,
+ ifl(1), ‘ grid write successful’
END DO

CALL DG_NTIM ( .false., .false., time, nxttm, ier )

FIG. 5 shows an alternate embodiment of AIC's PPI determination component. In all subsequent aspects of the diagram, reference aircraft and/or airfoil may be singular or plural, i.e. the AIC may be considered process multiple types in each request or the AIC may process a single type in a request. As in FIG. 4, the component processes the initial request 501 and aircraft type 502 and queries a PPI data repository 503. In this embodiment, if the requested aircraft type is not known to the AIC, the AIC may use an airfoil based on the aircraft size in which the largest PPI may eventually be generated 505. In this embodiment, the AIC may assign this airfoil to the aircraft for icing calculation purposes 506. The PPI calculation proceeds through requesting gridpoints and time 507, querying the AIC weather model 508, and determining the PPI for the given airfoil 509, as shown in FIG. 4. The requested PPI(s) are then output to the initiator of the request.

FIG. 6 shows an example of how the AIC may be incorporated into existing and/or prospective flight planning tools, such as AviationSentry Online®. The AIC may be included with online services, with desktop services, with mobile applications, and/or the like. In this embodiment of the disclosure, a flight planning tool has an interface 601 representative of an online flight planning service with user profile information. As an interactive element 602, the AIC may allow users to factor icing prediction into flight path creation. The AIC may allow users to consider several ways of incorporating icing prediction into their flight path considering their flight requirements 603. In this example, the AIC may offer shortest path generation where icing may not be a considering factor in flight path creation, icing circumvention where icing avoidance is a serious flight consideration, some icing circumvention with emphasis on shortest path generation where icing avoidance warrants some consideration, but may not be a primary goal and/or the like. The AIC may then generate a regional icing forecast within the specified flight path region 604 and suggest flight path alterations with respect to the level of icing circumvention desired. In this embodiment, the AIC outputs a color-coded map overlay where black may represent no necessary PPI, green may represent mild PPI, yellow may represent moderate necessary PPI, and red may represent severe necessary PPI.

FIG. 6A shows one example of an expanded logic flow diagram of flight path considerations when the AIC is part of an integrated flight planning tool. In one embodiment of the disclosure, the flight planning service may access/input user profile information 605 which may include such information as the type of aircraft and/or flight service such as passenger 606, private 607 and/or commercial cargo/transport 608, the consideration of which may influence icing avoidance (i.e. commercial cargo transport may prioritize shortest path with minimal evasion while passenger may emphasize discursive icing circumvention over speed or directness). The AIC may request additional user profile information for flight path construction 609. In some embodiments of the disclosure, such information may include the origin grid point and departure time of the flight, the destination grid point, and/or the maximum travel time the flight can utilize in constructing its path 611. In some embodiments of the disclosure, the AIC may infer user information from previously stored user profile data and/or prior flight path generation 612. In some embodiments, this information may include the aircraft type, its fuel requirements, its standard flying altitude, previous planned flight paths, and/or the like 613. In some embodiments, user profile and flight creation information that is both input and/or inferred by the AIC may be used to update the user profile data for future AIC use 614. In some embodiments of the disclosure, the AIC may use other stored profile information where similar parameters resulted in successful flight path creation. In some embodiments of the disclosure, the AIC may use additional input, such as those from sources external to the flight planning tool, such as historical flight plan data and/or the like. The AIC may then calculate the grid size of the region 615 over which the AIC may consider flight path creation, using input such as the origin, destination, maximum flight time, and/or facilities of the aircraft and/or type of flight. In some embodiments of the disclosure, two dimensional grid space may be considered for initial path planning purposes. In some embodiments of the disclosure, three dimensional grid space may be considered for path planning purposes. In some embodiments of the disclosure, two dimensional grid space may be considered for initial path planning purposes, which may then be integrated with additional dimensional information as necessary to accurately determine available grid space inside which the flight path may still meet flight path parameters.

In some embodiments of the disclosure, this initial input component may then be followed by AIC PPI calculation 616 of the generated geospatial grid region, some examples of which have been described in FIGS. 2, 3, 4 and 5. The AIC may create a PPI overlay to the generated grid region 618 and may request additional information about the desired parameters of the flight path through this grid region 618. In some embodiments of the disclosure, these parameters may include schedule-based path-finding (shortest path immediacy), schedule-based but with circumvention of acute icing (shortest path avoiding high hazard icing areas), discursive icing circumvention (navigating out of icing areas), and/or any combination of or intermediate stage to these parameters 619. The AIC may then use available input as described in the input component to determine all flight path creation parameters 620. The AIC may then create a flight path over the PPI grid region 621, considering flight path creation parameters 619. The AIC may then provide the user the proposed flight path as a terminal overlay, standard or high definition map overlay and/or the like 622, as is applicable to the flight planning tool. If the flight path is satisfactory 623, the user may then exit the flight path planning component of the AIC as an incorporated flight planning tool option. In some embodiments of the disclosure, the AIC may allow the user to export the determined flight path to other media, save the flight path to the user profile, share the flight path with additional users, and/or the like. In some embodiments of the disclosure, if the proposed flight path is not satisfactory 623, the AIC may allow the user to modify flight path creation parameters 624. In some embodiments of the disclosure, the user may re-enter a flight path creation component as specified earlier. In some embodiments of the disclosure, users may be allowed to visually manipulate flight path options using the proposed flight path PPI grid overlay. In some embodiments of the disclosure, the user may be able to reenter flight path creation, visually manipulate the proposed flight path and/or combine these methods in any intermediate path modification.

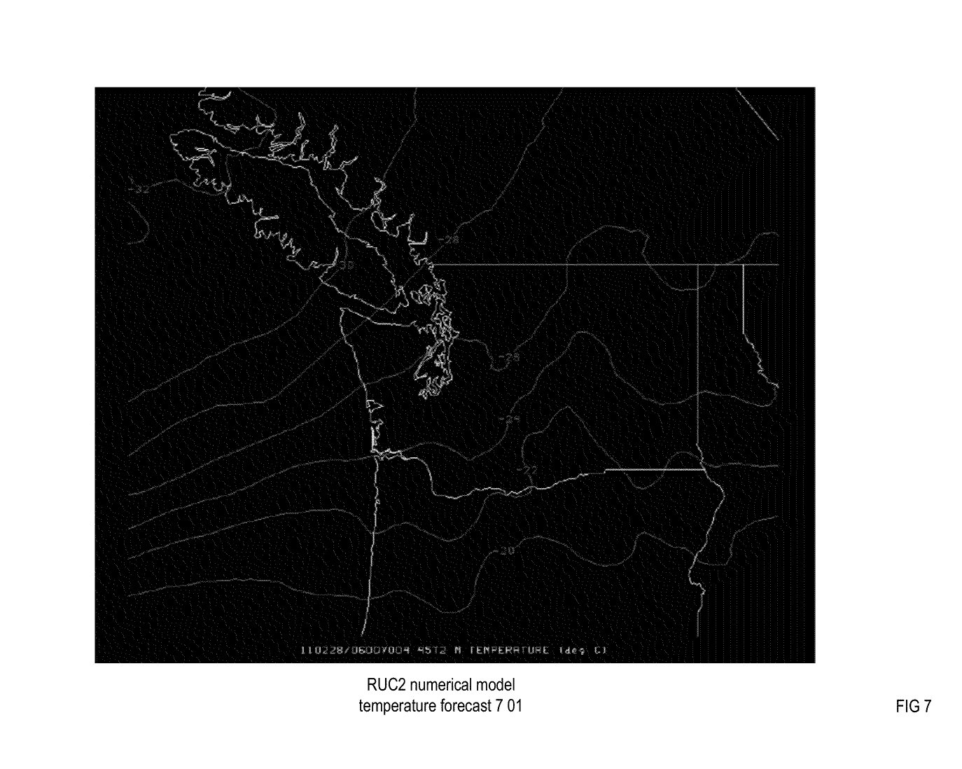

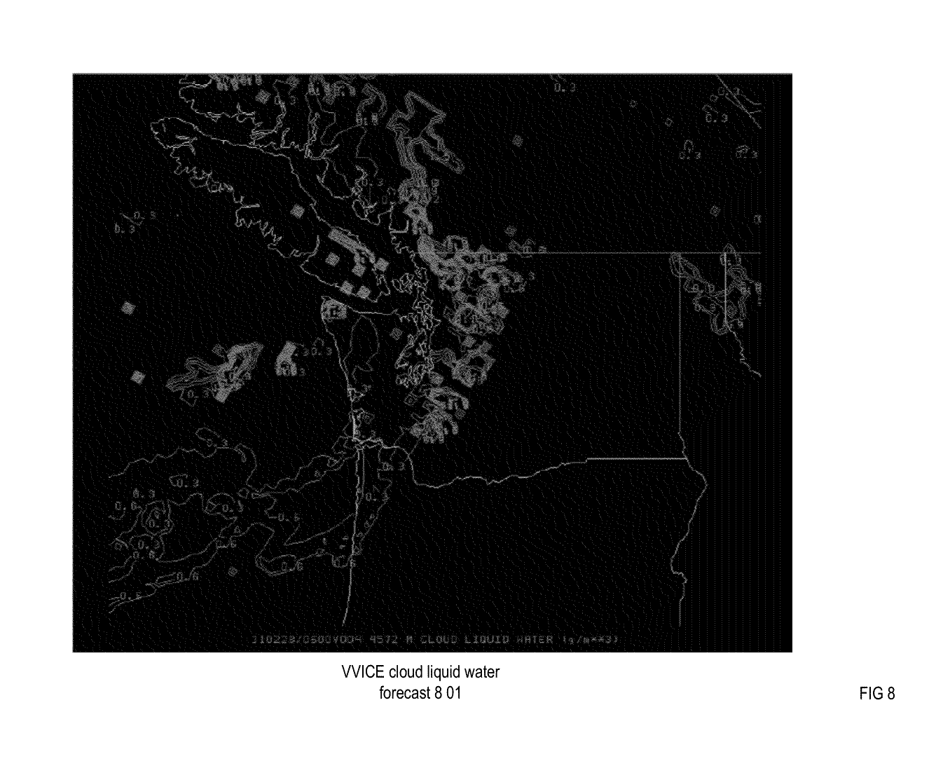

FIG. 7 shows an example four-hour Rapid Refresh model data (RUC2 format) numerical temperature forecast at 4572 m (FL150) over the Washington state region, which the AIC may use an input for PPI calculation.

FIG. 8 shows one example of cloud liquid water forecast 801 at FL150, as computed by the AIC using the model data of FIG. 7.

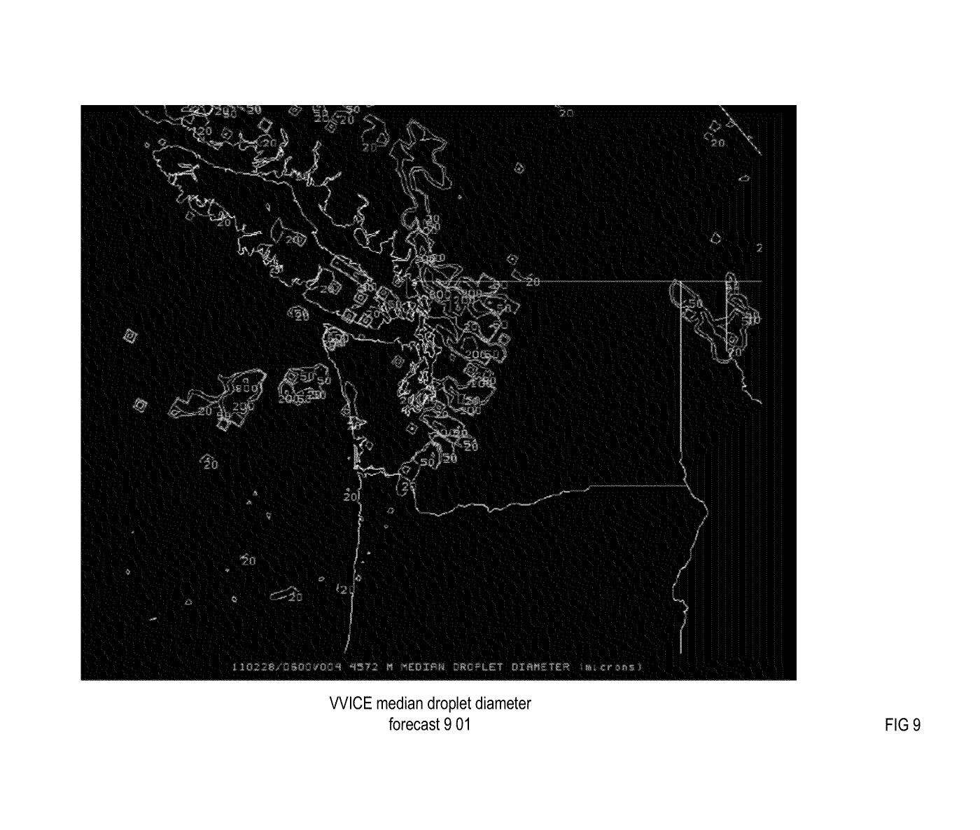

FIG. 9 shows one example of a median droplet diameter forecast 901 at FL150, as computed by the AIC using the model data of FIG. 7.

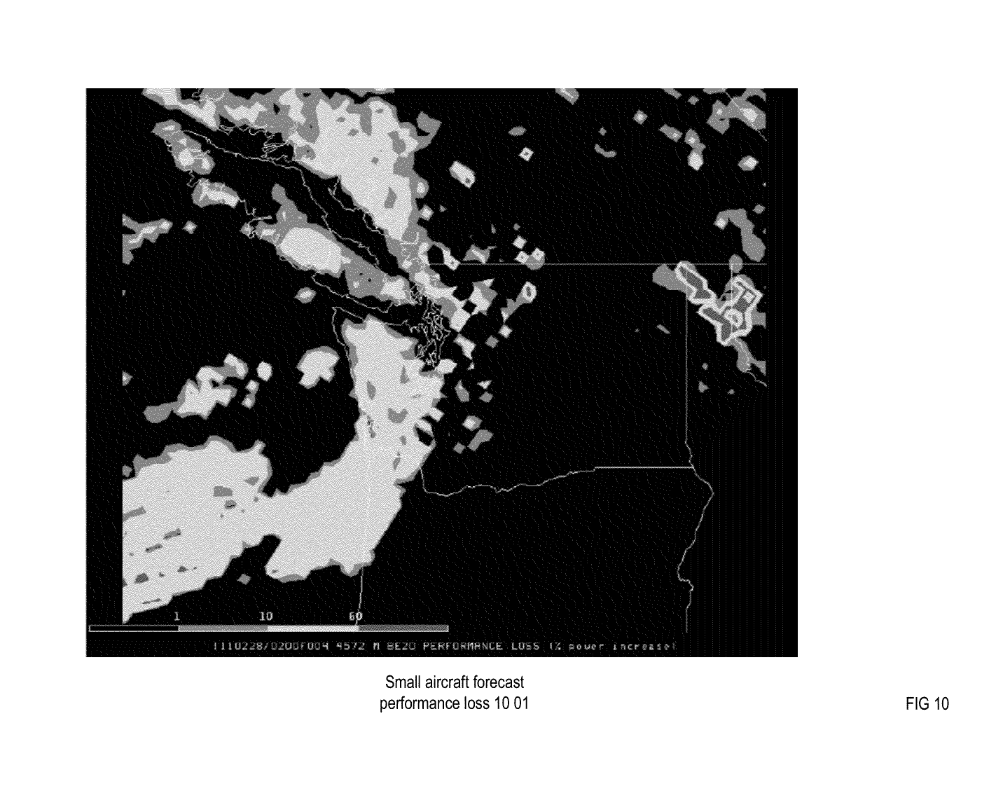

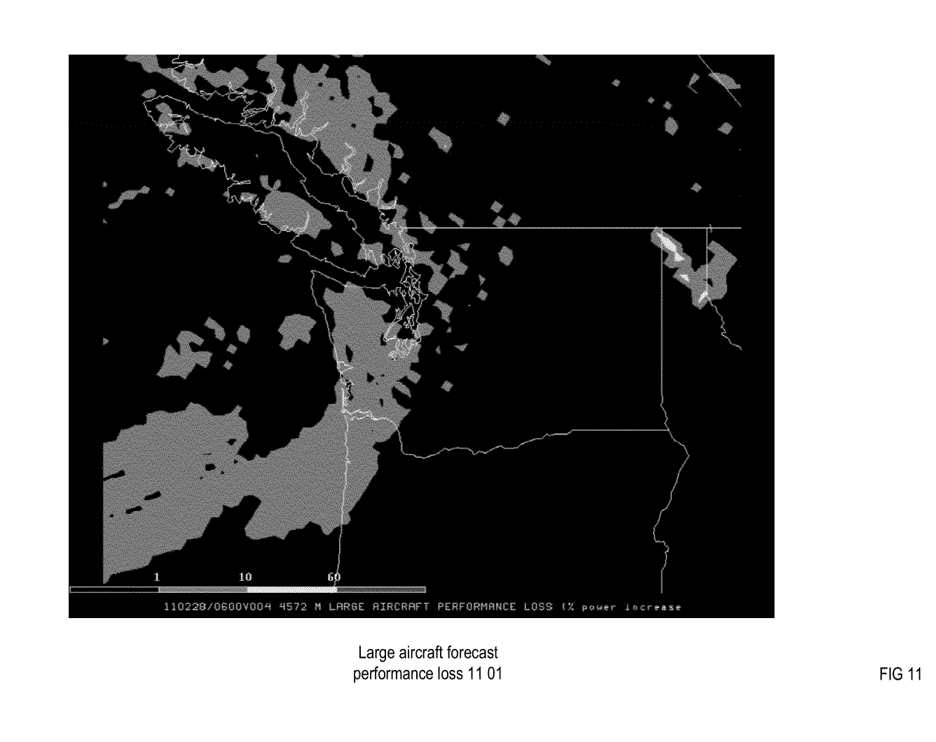

FIG. 10 shows one example of a color-coded PPI map grid overlay 1001 as calculated and generated by the AIC for the Beechcraft Super King 200 aircraft, if it were to fly in the icing conditions described in FIGS. 7-9. In this example, PPI is the percent power increase necessary to overcome performance loss after five minutes exposure to the shown icing conditions, where black indicates less than 1% PPI, green indicates less than 10% PPI, yellow indicates less than 60% PPI, and red indicates greater than 60% PPI.

FIG. 11 shows one example of a color-coded PPI map grid overlay 1101 as calculated and generated by the AIC for a larger aircraft than was shown in FIG. 10, if it were to fly in the icing conditions described in FIGS. 7-9. In this example, PPI is the percent power increase necessary to overcome performance loss after five minutes exposure to the shown icing conditions, where black indicates less than 1% PPI, green indicates less than 10% PPI, yellow indicates less than 60% PPI, and red indicates greater than 60% PPI.

In some embodiments, the AIC server may issue PHP/SQL commands to query a database table (such as FIG. 16, Profile 1619c) for profile data. An example profile data query, substantially in the form of PHP/SQL commands, is provided below:

<?PHP
header(′Content-Type: text/plain′);
// access database server
mysql_connect(“254.93.179.112”,$DBserver,$password);
// select database table to search
mysql_select_db(“AIC_DB.SQL”);
//create query
$query = “SELECT field1 field2 field3 FROM ProfileTable WHERE user
LIKE

′%′ $prof”;

// perform the search query
$result = mysql_query($query);
// close database access
mysql_close(“AIC_DB.SQL”);
?>

The AIC server may store the profile data in a AIC database. For example, the AIC server may issue PHP/SQL commands to store the data to a database table (such as FIG. 16, Profile 1619c). An example profile data store command, substantially in the form of PHP/SQL commands, is provided below:

<?PHP
header(′Content-Type: text/plain′);
// access database server
mysql_connect(“254.92.185.103”,$DBserver,$password);
// select database to append
mysql_select(“AIC_DB.SQL”);
// add data to table in database
mysql_query(“INSERT INTO ProfileTable

(fieldname1, fieldname2, fieldname3)
VALUES ($fieldvar1, $fieldvar2, $fieldvar3)”);

// close connection to database
mysql_close(“AIC_DB.SQL”);
?>

Various embodiments of the AIC may be used to provide real-time, pre-flight and/or in-flight icing reporting, planning and response. The integrated, unified icing system provided by the AIC may be used in flight equipment and/or ground equipment. The AIC may provide weather/aviation decision support (e.g., via graphical displays) and/or provide alerts/triggers. Although it is discussed in terms of re-routing in time of increased icing, in some embodiments, the AIC may identify more efficient paths based on real-time updates where there is decreased icing over a shorter physical distance, and may update a flight plan accordingly. The AIC identifies 4D areas for flight hazards, and a user may choose or set their profile based on particular hazards (e.g., a passenger airline would have a different hazard/icing profile than an air freight company, and a large airliner would have a different profile from a small plane or helicopter). Various cost calculations and risk calculations may also be used in determining alerts and/or flight paths. In some embodiments, real-time feedback may come from plane-mounted instrument sensors and provide updates to predicted icing. Such information may be used to refine components for icing determination. Although examples were discussed in the context of jet airliners, it is to be understood that the AIC may be utilized for low-level services, such as helicopters, unmanned aerial vehicles, as well as high speed and/or military aircraft, and may even have potential ground applications, especially in mountainous terrain. The AIC may work with air traffic control, particularly in management of routing. In some embodiments, the AIC may receive input from and render output directly to avionics systems to guide planes.

Many pilots view aircraft icing as one of the most dangerous in-flight hazards. Prior to the AIC, icing forecasts have been one-size-fits-all. Different aircraft accumulate ice differently even in the same meteorological environment, and thus a generic icing forecast may not be useful to a pilot. The AIC addresses this situation by providing a universal and objective quantitative metric for aircraft performance loss and applying it to ice accumulation for specific airfoils. In some embodiments, an icing component, module or program, such as NASA LEWICE, may be used to generate the accumulations and a computational fluid dynamics (CFD) component, module or program to analyze the resulting performance losses, and the AIC generates aircraft-specific icing forecasts.

In some embodiments, ice accumulation on aircraft surfaces may depend on many aerodynamic (e.g., body shape, body size, angle attack, exposure time, and flight speed) and meteorological variables (e.g., air temperature, liquid water content (LWC), and median volume droplet (MVD) size). In some embodiments, the AIC, utilizing one or more various thermodynamic analysis (TdA) components, modules, and/or programs (e.g., LEWICE 3.2.2 software) may evaluate the thermodynamics of supercooled droplets as they impinge on a body given aerodynamic, flight, and atmospheric inputs and compute the resulting ice shape(s). Using computation fluid dynamics (CFD) component(s), the AIC may analyze aerodynamic performance changes. In some embodiments, a CFD component may solve equations of motion for the resulting airflow. In some embodiments, the Percent Power Increase (PPI) metric may be determined and/or computed from CFD results, providing an elegant way to quantify the post-icing performance change. For additional detail, see McCann, D. W. and P. R. Kennedy, 2000: Percent power increase. Proc. 9^{th} Conf. on Aviation, Range, and Aerospace Meteorology, Amer. Meteor. Soc., Boston Mass., 266-269, the entirety of which is hereby incorporated by reference.

For example, in some implementations, lift and drag are functions of the aircraft's speed (V)

$$Lift = {C}_{L} A \frac{ρ {V}^{2}}{2}$$

$$Drag = {C}_{D} A \frac{ρ {V}^{2}}{2}$$

where ρ is the air density, A is the aircraft component's cross sectional area, and C_{L} and C_{D} are coefficients of lift and drag respectively. In this example, in order to maintain speed and altitude, the new thrust (power) is

$${Thrust}_{iced} = {Thrust}_{clean} \frac{{C}_{L : clean}}{{C}_{L : iced}} \frac{{C}_{D : iced}}{{C}_{D : clean}}$$

where the subscripts clean and iced indicate conditions before and after ice accumulation. Thus

$$PPI \times .01 = \frac{{Thurst}_{iced}}{{Thrust}_{clean}} - 1 = \frac{{C}_{L : clean}}{{C}_{L : iced}} \frac{{C}_{D : iced}}{{C}_{D : iced}} - 1$$

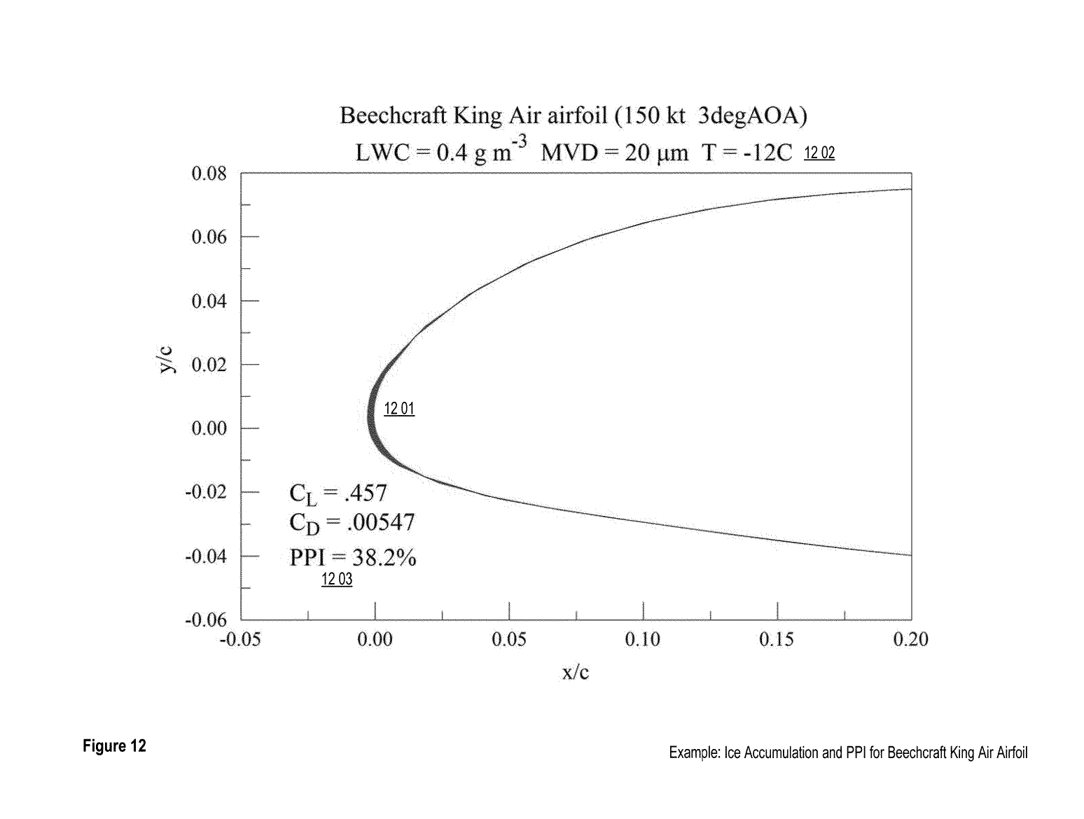

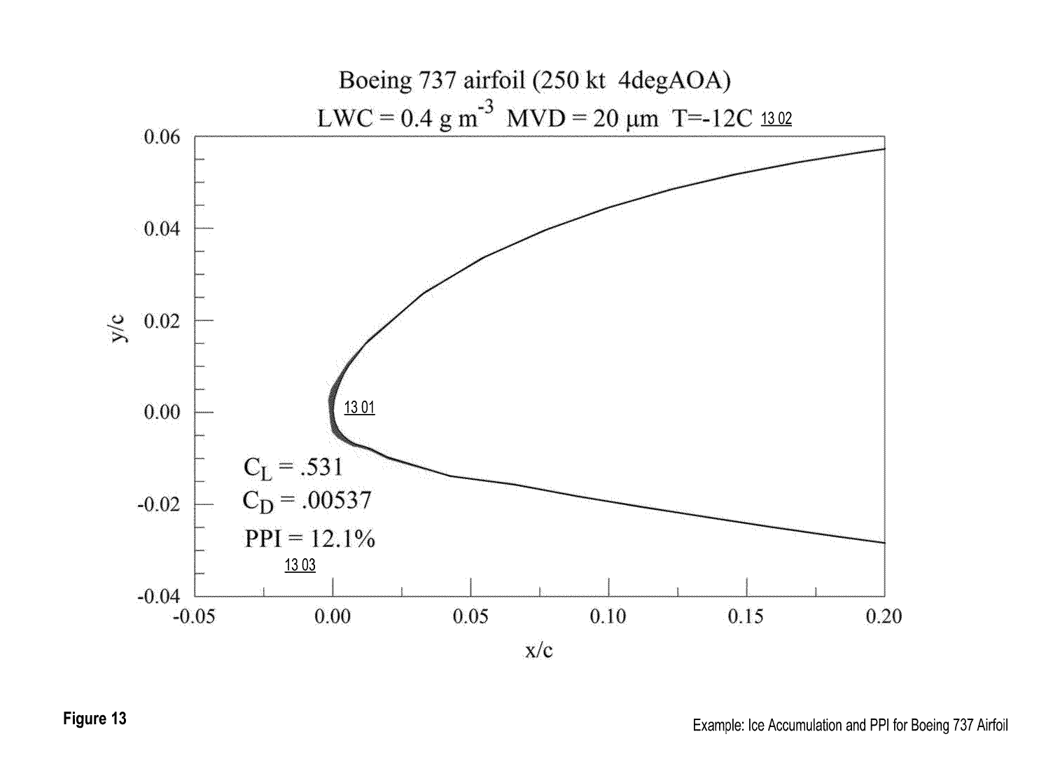

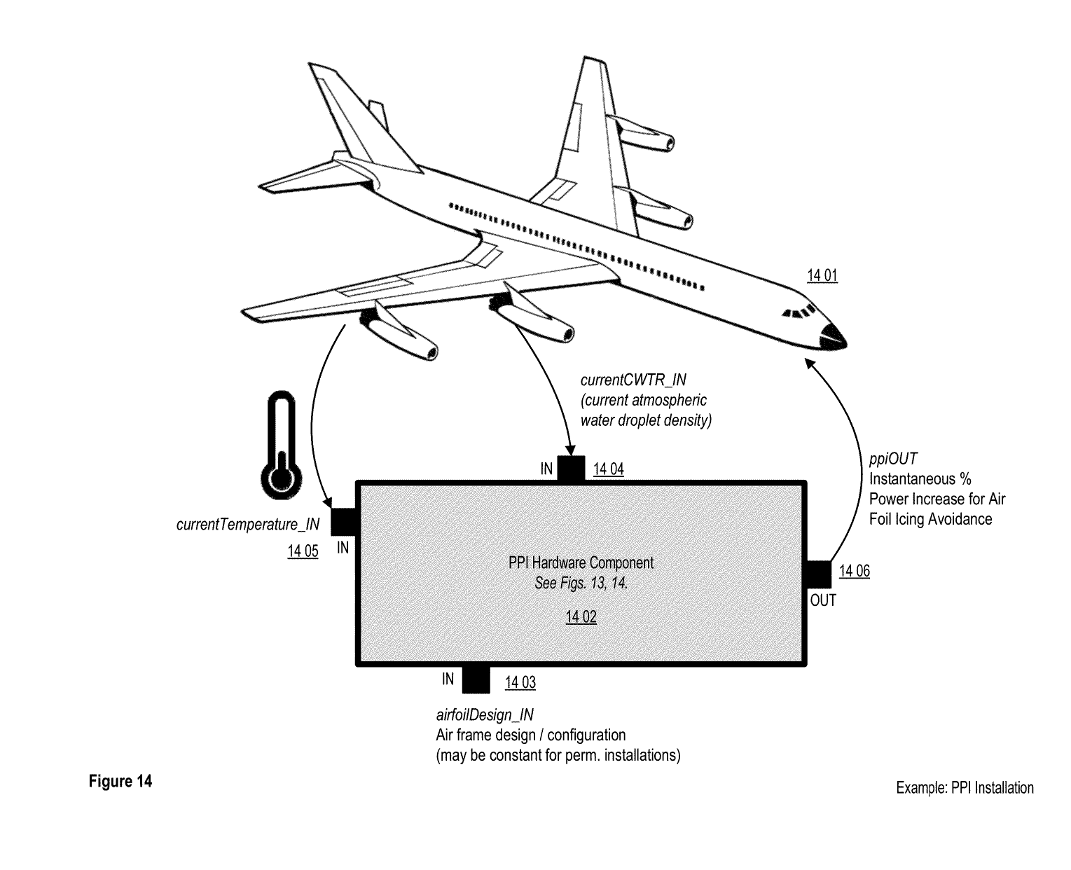

In some implementations of the AIC, this elegant relationship may be utilized to determine performance loss with ice accumulation on any airfoil. For example, FIGS. 12 and 13 show ice accumulation and resulting PPI values on a Beechcraft King Air airfoil and a Boeing 737 airfoil, respectively. FIG. 12 shows ice (red) accumulation, e.g., 1201, on a Beechcraft King Air airfoil using the inputs, e.g., 1202, in the figure. The resulting performance change is also shown, e.g., 1203. FIG. 13 shows ice (red) accumulation, e.g., 1301, on a Boeing 737 airfoil using the inputs, e.g., 1302, in the figure. The resulting performance change is also shown, e.g., 1303.

In some embodiments of the AIC, aircraft-specific icing forecasting may be a two element process. The AIC creates numerous ice accumulation simulations modifying the meteorological variables for each aerodynamic configuration. The combinations of air temperature, LWC, and MVD are may be limited by choosing representative values for each variable. For example, supercooled liquid water exists only in a finite range of air temperatures (0 C to −40 C). With temperatures less than about −20 C ice shapes are similar because supercooled drops freeze quickly. Similarly, cloud liquid water amounts rarely exceed 2 g m⁻³. While most icing occurs with small droplet sizes, supercooled large drops pose a significant icing threat, so the AIC may test ice shapes over a fairly large droplet size range. Properly implementated parameters provide significant ranges of variables to analyze. The AIC may select/receive representative values to ensure sufficient granularity yet limit the time necessary to create a PPI profile or determine a PPI value given a particular input set. A TdA component may create an ice shape for the chosen meteorological and aerodynamic configuration. In some implementations, a CFD component may analyze the resulting ice shape for the airfoil's performance. Various implementations may do hundreds or thousands of iterations to converge on a suitable solution. The AIC may be configured to create PPI profiles for as many aircraft as desired, or even for every available aircraft. Initially, PPI profiles may be generated for popular aircraft, both in terms of ownership and in terms of airfoil shapes and sizes used by manufacturers.

In some embodiments, aircraft-specific icing forecasts can be implemented with any forecast of air temperature, LWC, and MVD. Forecast air temperature may be determined or computed by numerical weather forecast (NWF) components. For example, a VVICE module may be utilized that post-processes any numerical model for the LWC and MVD. The VVICE module parameterizes vertical motions then uses straight-forward cloud physics relationships to create the cloud parameters (additional detail may be found in McCann, D. W., 2006: Parameterizing convective vertical motions for aircraft icing forecasts. Proc. 12^{th} Conf. on Aviation, Range, and Aerospace Meteorology, Amer. Meteor. Soc., Boston Mass., the entirety of which is hereby incorporated by reference).

In some embodiments, to produce an aircraft-specific forecast, the AIC makes a three-dimensional lookup table for every aircraft type for which a PPI profile was created. A user may specify an aircraft type, and the AIC interpolates the appropriate PPI profile table at every grid point, horizontally, vertically, and in time. If the selected aircraft type is not in the AIC database, the AIC may be configured with relatively more flexible tables based on aircraft size. Thus, the AIC can create horizontal maps at the user's requested altitude, cross sections along the user's requested flight path, and/or other useful displays.

By providing aircraft-specific icing forecasts, the AIC may remove much of the ambiguity inherent in previous one-size-fits-all icing forecasts. In particular, there may be a unique situation in which a particular aircraft may be more vulnerable to icing than a traditional forecast indicates. By providing icing hazards in quantitative terms, the AIC forecasts give more detail than previously available and pilots may utilize to the Percent Power Increase metric directly since increasing power is one of the ways a pilot can combat the effects of icing.

Moreover, by being aircraft-specific, the AIC forecasts may create goodwill with users. Knowing the icing forecasts are tailored to their aircraft type, users can better utilize and rely on forecasts as meaningful to them. This also creates less doubt about how to interpret the forecasts.

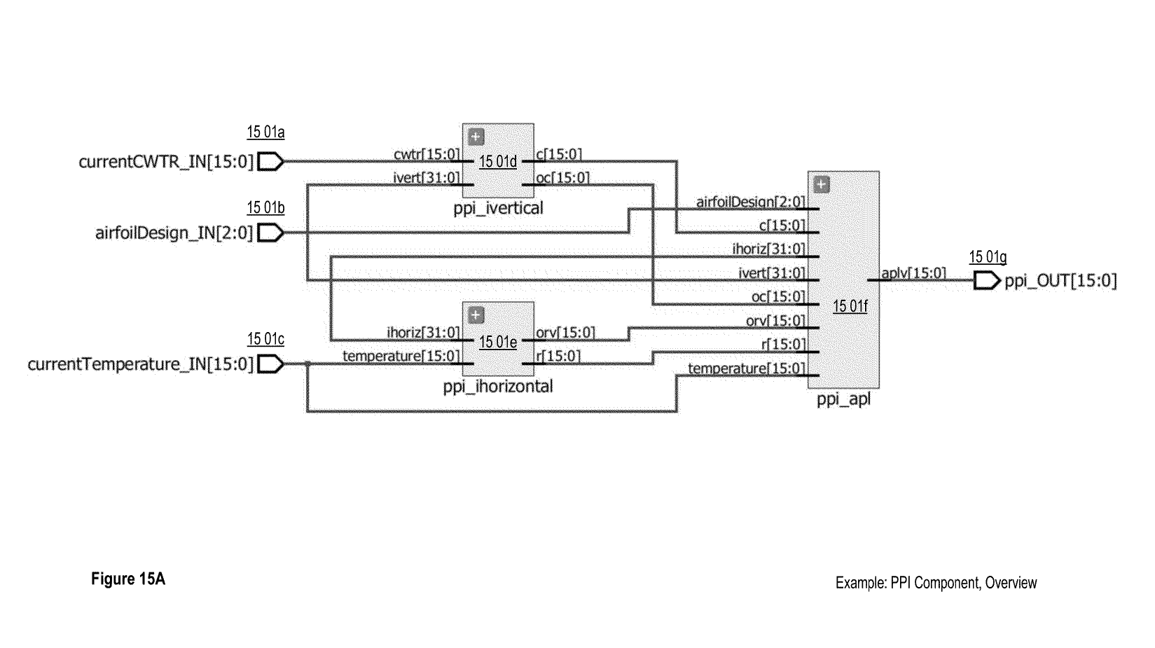

FIG. 14 illustrates an example PPI component installation. In one embodiment, an aircraft 1401 may have installed an AIC containing a PPI component 1402 for the determination of an instantaneous percent-power-increase value for a given input set. The PPI component may be configured, as in the current example, as an integrated hardware component containing one or more hardware logic circuits for determining a PPI value. In alternative embodiments, portions (or, in some cases, substantially all) of the PPI value determination may be performed by the AIC utilizing software commands substituted for one or more of the PPI component integrated hardware logic circuits. An example PPI component and configuration is disclosed herein and particularly with respect to FIG. 4, FIG. 5 and FIGS. 15A-F.

In one configuration, airplane 1401 may provide an electrical signal to airfoilDesign_IN terminal 1403 representing the aircraft or airfoil design on which the PPI value determination is to be made. For example, if the current aircraft in which the PPI component is installed is a Boeing 737, the aircraft flight control software may signal a value of “101” on airfoilDesign_IN, that value representing the current aircraft type. The value “101” may be expressed as three electrical voltages (“high-low-high”) across three airfoilDesign_IN hardware input pins. By utilizing three input pins, the airfoilDesign_IN input may be used to represent at least 7 different aircraft configurations (e.g., “000”, “001”, “010”, “100”, “110”, “101”, “111”). By way of further examples, in one embodiment “110” may represent a Beechcraft Super King 200 aircraft, “111” may represent a default medium-body airframe, etc. In alternative embodiments, additional hardware input pins or other serial communication input may be utilized to allow the PPI component to determine instantaneous PPI values for a limitless number of aircraft and/or airfoil designs.

In one embodiment, aircraft 1401 may provide the PPI component 1402 with input, using currentCWTR_IN terminal 1404, representing the current atmospheric water droplet density. The value provided may be electrical signals representing an integer value. For example, if the aircraft water density sensor determines that the current water density about the aircraft is 0.002, the aircraft may signal the integer value of “2” (representing 0.002*1000) to currentCWTR_IN. In one embodiment, the value “2” may be represented as a 16-bit value (e.g., “0000 0000 0000 0010”) signaled as 16 high-or-low voltages across an equivalent number of hardware input pins. Additionally, airplane 1401 may similarly signal a current ambient temperature value for the temperature about the plane to PPI input currentTemperature_IN terminal 1405.

As disclosed herein, the PPI component configuration discussed with respect to FIG. 14 may be utilized to determine an instantaneous PPI value for a current airframe and ambient condition inputs. However, other PPI component configurations may be utilized in association with the other embodiments of the AIC discussed herein. For example, if the PPI component is configured to provide a PPI value for a point in space an aircraft will encounter after 10-minutes of further flight time (e.g., a future point/time), then the values provided to currentCWTR_IN and currentTemperature_IN may be estimated values for that time/location. In further embodiments, the discrete PPI value determinations by the PPI component may be utilized to perform an optimized flight-path determination. For example, the PPI component may be repeatedly utilized to determine PPI values for all points in a 3-D space. In an alternate embodiment, the PPI component may have multiple input/output terminals and/or accept an array of inputs and provide an array of outputs on one or more input/output terminals. As such, the PPI component embodiment described herein may be utilized with the other components of the AIC to perform any or all of the embodiments of the AIC described herein.

Additionally, it should be noted that the signal inputs/outputs disclosed herein are representative of example PPI component inputs/outputs. For example, a PPI input for aircraft type may be represented as a single aircraft designator, an airfoil designator, an aircraft airfoil configuration (e.g., a representation of airfoil geometry such as, for example, a height and angle of curvature), a default designator (e.g., “medium aircraft”), and/or the like. Further, the percent-power-increase output value determination may be made by the PPI component on the basis of inputs other than those illustrated herein without departing from the disclosure. For example, the PPI component may utilize the instantaneous or expected aircraft altitude in lieu of temperature, may utilize a cloud density forecast in lieu of water droplet density, and/or the like.

FIG. 15A shows an example PPI hardware component. In one embodiment, an aircraft flight planning system and/or the like may provide electrical inputs to the PPI component. Thereafter, the one or more electrical inputs may be processed by the logic circuits (for example, integrated ASIC's, FPGA's, and/or the like) to produce a percent-power-increase value representing the PPI for the given aircraft and input parameters. In one embodiment, the flight planning system may provide an atmospheric water droplet density value currentCWTR_IN 1501a, an airfoil or aircraft design or state value airfoilDesign_IN 1501b, a temperature value currentTemperature_IN 1501c, and/or the like and receive as output electrical signals representing a determined PPI value, e.g., ppi_OUT 1501g.

In one embodiment, the atmospheric water droplet density is provided to a ppi_ivertical PPI sub-component 1501d, which is described herein with respect to FIG. 15C and the temperature value is provided to a ppi_ihorizontal PPI sub-component 1501e, which is described herein with respect to FIG. 15B. In one embodiment, the output from both the ppi_ivertical and ppi_ihorizontal PPI sub-components as well as one or more of the original input signals are provided to a ppi_apl PPI sub-component 1501f, which is described herein with respect to FIG. 15D. In one embodiment, the ppi_apl PPI sub-component may provide a calculated PPI value to the PPI component, which may be output on ppi_OUT terminal 1501g.

In one embodiment, a PPI hardware component, represented substantially in the form of VHDL hardware description statements suitable for configuring an FPGA to operate as an integrated hardware logic circuit performing the features described herein, is:

library IEEE;
use IEEE.STD_LOGIC_1164.ALL;
use IEEE.NUMERIC_STD.ALL;
entity PPI_Component is

Port ( airfoilDesign_IN : in STD_LOGIC_VECTOR(2
downto 0);

currentCWTR_IN : in STD_LOGIC_VECTOR(15
downto 0);
currentTemperature_IN : in
STD_LOGIC_VECTOR(15 downto 0);
ppi_OUT : out STD_LOGIC_VECTOR (15
downto 0)

);

end PPI_Component;
architecture PPI of PPI_Component is
--sub-component to determine vertical (icol) offset
--assumes cwtr values are multiplied by 1,000 (so .001 is input as
“1”)
component ppi_ivertical is

port(cwtr : in signed;

ivert : inout integer;
c : inout signed;
oc : inout signed

);

end component;
signal ivert : integer;
signal c, oc : signed(15 downto 0);
--sub-component to determine horizontal (irow) offset
--assumes temp is inverse of value input
--(so −32deg is input as “32”)
component ppi_ihorizontal is

port(temperature : in signed;

ihoriz : inout integer;
r : inout signed;
orv : inout signed

);

end component;
signal ihoriz : integer;
signal r, orv : signed(15 downto 0);
--sub-component to determine customized airframe PPI
component ppi_apl is

port ( temperature : in signed;

airfoilDesign : in signed;
ihoriz : integer;
ivert : integer;
c : in signed;
oc : in signed;
r : in signed;
orv : in signed;
aplv : inout signed

);

end component;
signal aplv : signed(15 downto 0);
begin

--sub-components
CPNT_ppi_ivertical : ppi_ivertical port

map (signed(currentCWTR_IN),ivert,c,oc);

CPNT_ppi_ihorizontal : ppi_ihorizontal port

map (signed(currentTemperature_IN),ihoriz,r,orv);

CPNT_ppi_apl : ppi_apl port

map (signed(currentTemperature_IN),
signed (airfoilDesign_IN),ihoriz,ivert,c,oc,r,orv,aplv);

--output PPI
process(airfoilDesign_IN)
begin

ppi_OUT <= std_logic_vector(aplv);

end process;

end PPI;

FIG. 15B represents a ppi_ihorizontal PPI sub-component. The sub-component takes input temperature 1502b and outputs a horizontal offset value for PPI determination, e.g., 1502a and one or more coefficient values for use by the ppi_apl PPI sub-component, e.g., 1502c, 1502d. Within the ppi_ihorizontal sub-component, the input value signal crosses a plurality of logic gates as represented herein and described below. In one embodiment, a ppi_ihorizontal PPI sub-component, represented substantially in the form of VHDL hardware description statements suitable for configuring an FPGA to operate as an integrated hardware logic circuit performing the features described herein, is:

library IEEE;
use IEEE.STD_LOGIC_1164.ALL;
use IEEE.NUMERIC_STD.ALL;
entity ppi_ihorizontal is

Port ( temperature : in signed;

ihoriz : inout integer;
r : inout signed;
orv : inout signed

);

end ppi_ihorizontal;
architecture Behavioral of ppi_ihorizontal is
begin

process(temperature)
begin

if (temperature > to_signed(2,16)) then

ihoriz <= 1;
r <= resize (temperature / to_signed(2,16),16);

else

if (temperature > to_signed(4,16)) then

ihoriz <= 1;
r <= resize ((temperature −

to_signed(2,16)) / to_signed(2,16),16);

orv <= to_signed(1,16) − r;

else

ihoriz <= to_integer((signed(temperature) /
to_signed(4,16)));
r <= to_signed(0,16);
orv <= to_signed(1,16);

end if;

end if;

end process;

end Behavioral;

FIG. 15C represents a ppi_ivertical PPI sub-component. The sub-component takes input atmospheric water droplet density 1503a and outputs a vertical offset value for PPI determination, e.g., 1503d and one or more coefficient values for use by the ppi_apl PPI sub-component, e.g., 1503b, 1503c. Within the ppi_ivertical sub-component, the input value signal crosses a plurality of logic gates as represented herein and described below. In one embodiment, a ppi_ivertical PPI sub-component, represented substantially in the form of VHDL hardware description statements suitable for configuring an FPGA to operate as an integrated hardware logic circuit performing the features described herein, is:

library IEEE;
use IEEE.STD_LOGIC_1164.ALL;
use IEEE.NUMERIC_STD.ALL;
entity ppi_ivertical is

Port ( cwtr : in signed;

ivert : inout integer;
c : inout signed;
oc : inout signed

);

end ppi_ivertical;
architecture Behavioral of ppi_ivertical is
signal rcol : signed(15 downto 0);
begin

process(cwtr)
begin

if (cwtr <= to_signed(1,16)) then

rcol <= resize(cwtr * to_signed(10,16),16);
ivert <= to_integer(rcol);
c <= rcol − ivert;
oc <= to_signed(1,16) − c;

else

if (cwtr <= to_signed(2,16)) then

rcol <= resize (to_signed(10,16) +

((cwtr − to_signed(1,16)) *
to_signed(4,16)),16);

ivert <= to_integer(rcol);

else

ivert <= 14;

end if;

end if;
end process;

end Behavioral;

FIG. 15D represents a ppi_apl PPI sub-component. The sub-component takes inputs airfoil design, temperature, and the output from ppi_ihorizontal and ppi_ivertical, e.g., 1504a, and provides output representing an instantaneous PPI value, e.g., 1504e. Within the ppi_apl sub-component, the input value signal crosses a plurality of logic gates as represented herein and described below and which may route the inputs to one or more of a plurality of airframe specific customization modules, e.g., airFrame_boeing747 1504b, airFrame_defaultMed 1504c, airframe_bCKingAir 1504d. An example airframe specific customization module is described herein with respect to FIGS. 15E-F. Although three airframe customization modules have been illustrated herein, other embodiments may contain only one airframe customization module (e.g., in the case of a “hard” installation that will only be used with respect to one airframe). Furthermore, in other embodiments the airframe customization modules may be provided as a “snap in” module that may be connected to the PPI component after manufacture. In still other embodiments, the airframe customization module's capabilities may be performed by a local data/logic store (such as, for example, that disclosed with respect to FIG. 16), a remote data/logic store (for example, by transmitting an in-flight wireless signal to a remote airframe customization module configured to respond to remote queries), or via a specially configured general purpose computing platform (such as, for example, that disclosed herein and particularly with respect to FIG. 4 and FIG. 5, which describe alternate PPI component configurations). In one embodiment, a ppi_apl PPI sub-component, represented substantially in the form of VHDL hardware description statements suitable for configuring an FPGA to operate as an integrated hardware logic circuit performing the features described herein, is:

library IEEE;
use IEEE.STD_LOGIC_1164.ALL;
use IEEE.NUMERIC_STD.ALL;
entity ppi_apl is

| | |
|---|---|
| Port ( | temperature : in signed; |

airfoilDesign : in signed;
ihoriz : in integer;
ivert : in integer;
c : in signed;
oc : in signed;
r : in signed;
orv : in signed;
aplv : inout signed

);

end ppi_apl;
architecture Behavioral of ppi_apl is
component airFrame_bCKingAir is

| | |
|---|---|
| port( | temperature : in signed; |

ihoriz : in integer;
ivert : in integer;
airFrame_val : inout signed

);

end component;
signal airFrame_bCKingAir_val : signed(15 downto 0);
component airFrame_boeing747 is

| | |
|---|---|
| port( | temperature : in signed; |

ihoriz : in integer;
ivert : in integer;
airFrame_val : inout signed

);

end component;
signal airFrame_boeing747_val : signed(15 downto 0);
component airFrame_defaultMed is

| | |
|---|---|
| port( | temperature : in signed; |

ihoriz : in integer;
ivert : in integer;
airFrame_val : inout signed

);

end component;
signal airFrame_defaultMed_val : signed(15 downto 0);
begin

--airframe customization modules
CPNT_airFrame_bCKingAir : airFrame_bCKingAir port

map (temperature,ihoriz,ivert,airframe_bCKingAir_val);

CPNT_airFrame_boeing747 : airFrame_boeing747 port

map
(temperature,ihoriz,ivert,airFrame_boeing747_val);

CPNT_airFrame_defaultMed : airFrame_defaultMed port

map
(temperature,ihoriz,ivert,airFrame_defaultMed_val);

process (ihoriz, ivert, c, oc, r, orv)
begin

if (airfoilDesign = 1) then

aplv <= resize(airFrame_bCKingAir_val * r,16);

else

if (airfoilDesign = 2) then

aplv <= resize(airFrame_boeing747_val * orv,16);

else

aplv <= resize(airFrame_defaultMed_val,16);

end if;

end if;

end process;

end Behavioral;

FIG. 15E represents a PPI sub-component aircraft customization module. The aircraft customization module takes as input horizontal/vertical offset values, e.g., 1505a, 1505b, and temperature 1505c and outputs an airframe customization value 1505e for use in determining airframe specific PPI. Within the sub-component, the input value signal crosses a plurality of logic gates as represented herein and described below. Furthermore, the aircraft customization module may contain non-volatile memory such as ROMs 1505d for storing airframe specific customization parameters. The aircraft customization module represented herein is for a Beechcraft Super King 200 aircraft. However, similarly configured customization modules may be used for other aircraft or airframes. In one embodiment, a PPI sub-component aircraft customization module, represented substantially in the form of VHDL hardware description statements suitable for configuring an FPGA to operate as an integrated hardware logic circuit performing the features described herein, is:

library IEEE;
use IEEE.STD_LOGIC_1164.ALL;
use IEEE.NUMERIC_STD.ALL;
entity airFrame_bCKingAir is

| | |
|---|---|
| Port ( | temperature : in signed; |

ihoriz : in integer;
ivert : in integer;
airFrame_val : inout signed

);

end airFrame_bCKingAir;
architecture Behavioral of airFrame_bCKingAir is
--airfoil customization params
type airfoilDesignParams is array (1 to 10, 1 to 7) of integer;
shared variable airfoil_p1: airfoilDesignParams :=(

(0,0,0,0,0,0,0),
(62,110,160,164,172,176,184),
(31,62,157,228,369,440,448),
(21,42,83,117,289,376,548),
(16,31,62,78,156,250,438),
(12,25,50,62,88,100,297),
(10,21,42,52,73,83,141),
(8,18,36,45,62,71,89),
(8,16,31,39,55,62,78),
(7,14,28,35,49,56,69)

);
shared variable airfoil_p2: airfoilDesignParams :=(

(0,0,0,0,0,0,0),
(188,196,200,208,212,220,224),
(452,460,464,472,476,484,488),
(634,724,728,736,740,748,752),
(531,719,812,1000,1004,1012,1016),
(395,592,690,887,985,1182,1280),
(242,445,546,749,851,1053,1154),
(98,286,390,597,701,908,1011),
(86,121,226,437,542,752,850),
(76,90,97,270,377,590,696)

);
signal INT_ihoriz, INT_ivert : integer :=0;
begin

process (ihoriz, ivert)
begin

--determine horiz and vert offset values
if (temperature > to_signed(2,16)) then

INT_ihoriz <= ihoriz;
INT_ivert <= ivert + 1;

else

INT_ihoriz <= ihoriz + 1;
INT_ivert <= ivert;

end if;
--return correct offset value
if (INT_ivert <= 7) then

airFrame_val <=
to_signed(airfoil_p1(INT_ihoriz,INT_ivert),16);

else

airFrame_val <=
to_signed(airfoil_p2(INT_ihoriz,INT_ivert−7),16);

end if;

end process;

end Behavioral;

FIG. 15F is an alternate representation of the Beechcraft Super King 200 airframe customization module described with respect to FIG. 15E. However, in this representation each of the internal input wires carrying component signals representing the input values have been broken out to further the reader's understanding. For example, the input for temperature has been represented herein as 16 wires each capable of providing a single “1” or “0” (e.g., high/low voltage) input. The aircraft customization module takes as input horizontal/vertical offset values, e.g., 1506a, 1506b, and temperature 1506c, utilizes the described logic gates and ROMs 1506d, and outputs an airframe customization value 1506e for use in determining airframe specific PPI, as further described herein and particularly above with respect to FIG. 15E.

Throughout this disclosure, ‘atmospheric data’ may refer to any environmental data related to the atmosphere, e.g., at some point of interest. By way of non-limiting example, the atmospheric data received and/or processed by the DATCM may include one or more of the following: temperature, moisture/water content, humidity, pressure, wind speed, wind direction, local EDR, wind shear, liquid water content, ozone concentration, pollution, and/or the like. Atmospheric data may comprise partial or full contents of forecast models (e.g., numerical weather forecast model data), meteograms, atmospheric soundings, surface observations, radar pictures, meteorological charts (e.g., surface pressure charts), weather maps, numerical weather prediction maps, and/or the like. Atmospheric data may, in some embodiments, be obtained directly or indirectly from sensors (e.g., infrared radiometers, microwave radiometers, hygrometers, pitot-static systems, gyroscopes, thermometers, barometers, optical sensors, radar, lidar, sodar, ceilometers, spectrometers, weather balloons, water vapor sensors, and/or the like), as well as from pilot reports. Depending on the embodiment, instruments (e.g., sensors) for measuring the atmospheric data used by the DATCM may be positioned in/on the aircraft itself, may be located on earth (e.g., as part of a grounded weather station), and/or may be part of an extraneous system, such as a weather balloon, satellite, avionics on another aircraft/spacecraft, etc.

Various embodiments of the AIC are contemplated by this disclosure, with the below exemplary, non-limiting embodiments A1-A86 provided to illustrate aspects of some implementations of embodiments of the AIC.

A1. A dynamic AIC platform processor-implemented flight planning method, comprising: receiving parameter data for an initial anticipated flight plan; determining airfoil type for an aircraft associated with the initial anticipated flight plan; obtaining atmospheric data based on the flight plan parameter data; determining a plurality of four-dimensional grid points based on the flight plan parameter data; determining corresponding icing data for each point of the plurality of four-dimensional grid point based on the airfoil type; determining via a processor a percent power increase for the initial anticipated flight plan; determining an at least one alternative flight plan based on the flight plan parameter data and the determined percent power increase for the initial anticipated flight plan; and providing the determined at least one alternative flight plan.

A2. The method of embodiment A1, wherein the parameter data includes aircraft data.

A3. The method of embodiment A1 or A2, wherein the parameter data includes the airfoil type.

A4. The method of any of the preceding embodiments, wherein the initial anticipated flight plan comprises a shortest route flight plan.

A5. The method of any of the preceding embodiments, wherein the at least one alternative flight plan comprises an optimized route flight plan.

A6. The method of embodiment A5, wherein the optimized route flight plan is optimized for safety.

A7. The method of embodiment A6, wherein the optimized route flight plan is optimized for safety and fuel consumption.

A8. The method of any of the preceding embodiments, wherein the flight plan parameter data includes take-off time.

A9. The method of any of the preceding embodiments, wherein the flight plan parameter data includes take-off location.

A10. The method of any of the preceding embodiments, wherein the flight plan parameter data includes destination location.

A11. A dynamic AIC platform flight planning system, comprising: means to receive parameter data for an initial anticipated flight plan; means to determine airfoil type for an aircraft associated with the initial anticipated flight plan; means to obtain atmospheric data based on the flight plan parameter data; means to determine a plurality of four-dimensional grid points based on the flight plan parameter data; means to determine corresponding icing data for each point of the plurality of four-dimensional grid point based on the airfoil type; means to determine a percent power increase for the initial anticipated flight plan; means to determine an at least one alternative flight plan based on the flight plan parameter data and the determined percent power increase for the initial anticipated flight plan; and means to provide the determined at least one alternative flight plan.

A12. The system of embodiment A11, wherein the parameter data includes aircraft data.

A13. The system of embodiment A11 or A12, wherein the parameter data includes the airfoil type.

A14. The system of any of embodiment(s) A11, A12, or A13, wherein the initial anticipated flight plan comprises a shortest route flight plan.

A15. The system of any of embodiment(s) A11, A12, A13, or A14, wherein the at least one alternative flight plan comprises an optimized route flight plan.

A16. The system of embodiment A15, wherein the optimized route flight plan is optimized for safety.

A17. The system of embodiment A15 or A16, wherein the optimized route flight plan is optimized fuel consumption.

A18. The system of any of embodiment(s) A11, A12, A13, A14, A15, A16, or A17, wherein the flight plan parameter data includes take-off time.

A19. The system of any of embodiment(s) A11, A12, A13, A14, A15, A16, A17, or A18, wherein the flight plan parameter data includes take-off location.

A20. The system of any of embodiment(s) A11, A12, A13, A14, A15, A16, A17, A18, or A19, wherein the flight plan parameter data includes destination location.

A21. A processor-readable non-transitory medium storing processor-issuable dynamic AIC flight plan generating instructions to: receive parameter data for an initial anticipated flight plan; determine airfoil type for an aircraft associated with the initial anticipated flight plan; obtain atmospheric data based on the flight plan parameter data; determine a plurality of four-dimensional grid points based on the flight plan parameter data; determine corresponding icing data for each point of the plurality of four-dimensional grid point based on the airfoil type; determine a percent power increase for the initial anticipated flight plan; determine an at least one alternative flight plan based on the flight plan parameter data and the determined percent power increase for the initial anticipated flight plan; and provide the determined at least one alternative flight plan.

A22. The medium of embodiment A21, wherein the parameter data includes aircraft data.

A23. The medium of embodiment A21 or A22, wherein the parameter data includes the airfoil type.

A24. The medium of any of embodiment(s) A21, A22, or A23, wherein the initial anticipated flight plan comprises a shortest route flight plan.

A25. The medium of any of embodiment(s) A21, A22, A23, or A24, wherein the at least one alternative flight plan comprises an optimized route flight plan.

A26. The medium of embodiment A25, wherein the optimized route flight plan is optimized for safety.

A27. The medium of embodiment A25 or A26, wherein the optimized route flight plan is optimized for fuel consumption.

A28. The medium of any of embodiment(s) A21, A22, A23, A24, A25, A26, or A27, wherein the flight plan parameter data includes take-off time.

A29. The medium of any of embodiment(s) A21, A22, A23, A24, A25, A26, A27, or A28, wherein the flight plan parameter data includes take-off location.

A30. The medium of any of embodiment(s) A21, A22, A23, A24, A25, A26, A27, A28, or A29, wherein the flight plan parameter data includes destination location.

A31. A dynamic airfoil icing controller/platform flight planning apparatus, comprising: a processor; and a memory disposed in communication with the processor and storing processor-issuable instructions to: receive parameter data for an initial anticipated flight plan; determine airfoil type for an aircraft associated with the initial anticipated flight plan; obtain atmospheric data based on the flight plan parameter data; determine a plurality of four-dimensional grid points based on the flight plan parameter data; determine corresponding icing data for each point of the plurality of four-dimensional grid point based on the airfoil type; determine a percent power increase for the initial anticipated flight plan; determine an at least one alternative flight plan based on the flight plan parameter data and the determined percent power increase for the initial anticipated flight plan; and provide the determined at least one alternative flight plan.

A32. The apparatus of embodiment A31, wherein the parameter data includes aircraft data.

A33. The apparatus of embodiment A31 or A32, wherein the parameter data includes the airfoil type.

A34. The apparatus of any of embodiment(s) A31, A32, or A33, wherein the initial anticipated flight plan comprises a shortest route flight plan.

A35. The apparatus of any of embodiment(s) A31, A32, A33, or A34, wherein the at least one alternative flight plan comprises an optimized route flight plan.

A36. The apparatus of embodiment A35, wherein the optimized route flight plan is optimized for safety.

A37. The apparatus of embodiment A35 or A36, wherein the optimized route flight plan is optimized fuel consumption.

A38. The apparatus of any of embodiment(s) A31, A32, A33, A34, A35, A36, or A37, wherein the flight plan parameter data includes take-off time.

A39. The apparatus of any of embodiment(s) A31, A32, A33, A34, A35, A36, A37, or A38, wherein the flight plan parameter data includes take-off location.

A40. A dynamic AIC flight planning method, comprising: receiving a PPI flight parameter input associated with an aircraft; determining an airfoil type for the aircraft associated with the PPI flight parameter input; determining atmospheric data based on the PPI flight parameter input; providing the determined airfoil type and atmospheric data to a PPI component for the determination of a PPI icing avoidance value; receiving, from the PPI component, an indication of the determined PPI icing avoidance value; and providing the determined PPI icing avoidance value in response to the PPI flight parameter input.

A41. The method of embodiment A40, wherein the PPI flight parameter input is configured to represent the present airfoil configuration and atmospheric conditions being experienced by the aircraft.

A42. The method of embodiment A40, wherein the PPI flight parameter input is configured to represent the expected airfoil configuration and atmospheric conditions that will be experienced by the aircraft at a future point in time.

A43. The method of embodiment A40, wherein the determined atmospheric data includes a temperature.

A44. The method of embodiment A40, wherein the determined atmospheric data includes a value associated with the water content of the atmosphere about the aircraft at a point in time.

A45. The method of any of the embodiment(s) A41, A42, A43 or A44 wherein the PPI component is a hardware PPI component.

A46. The method of embodiment A45, wherein the hardware PPI component is an ASIC.

A47. The method of embodiment A45, wherein the hardware PPI component is an FPGA.

A48. The method of any of the embodiment(s) A41, A42, A43 or A44 wherein the PPI component is a PPI component containing processor executable instructions.

A49. The method of any of the embodiment(s) A41, A42, A43 or A44 wherein the PPI component is a PPI component composed of two-or-more sub-components.

A50. The method of embodiment A49, wherein the PPI component is comprised of a first sub-component in hardware for determining a first value associated with the PPI icing avoidance value and a second sub-component containing processor executable instructions for determining a second value associated with the PPI icing avoidance value.

A51. The method of embodiment A50, wherein the first and second value associated with the PPI icing avoidance value are used to determine the PPI icing avoidance value.

AA51. A dynamic AIC flight planning apparatus, comprising a processor, and a memory disposed in communication with the processor and storing processor-issuable instructions to perform the method of any of embodiments A40-A51.

A52. A dynamic AIC flight planning system, comprising: means to receive a PPI flight parameter input associated with an aircraft; means to determine an airfoil type for the aircraft associated with the PPI flight parameter input; means to determine atmospheric data based on the PPI flight parameter input; means to provide the determined airfoil type and atmospheric data to a PPI component for the determination of a PPI icing avoidance value; means to receive, from the PPI component, an indication of the determined PPI icing avoidance value; and means to provide the determined PPI icing avoidance value in response to the PPI flight parameter input.

A53. The system of embodiment A52, wherein the PPI flight parameter input is configured to represent the present airfoil configuration and atmospheric conditions being experienced by the aircraft.

A54. The system of embodiment A52, wherein the PPI flight parameter input is configured to represent the expected airfoil configuration and atmospheric conditions that will be experienced by the aircraft at a future point in time.

A55. The system of embodiment A52, wherein the determined atmospheric data includes a temperature.

A56. The system of embodiment A52, wherein the determined atmospheric data includes a value associated with the water content of the atmosphere about the aircraft at a point in time.

A57. The system of any of the embodiment(s) A53, A54, A55 or A56 wherein the PPI component is a hardware PPI component.

A58. The system of embodiment A57, wherein the hardware PPI component is an ASIC.

A59. The system of embodiment A57, wherein the hardware PPI component is an FPGA.

A60. The system of any of the embodiment(s) A53, A54, A55 or A56 wherein the PPI component is a PPI component containing processor executable instructions.

A61. The system of any of the embodiment(s) A53, A54, A55 or A56 wherein the PPI component is a PPI component composed of two-or-more sub-components.

A62. The system of embodiment A61, wherein the PPI component is comprised of a first sub-component in hardware for determining a first value associated with the PPI icing avoidance value and a second sub-component containing processor executable instructions for determining a second value associated with the PPI icing avoidance value.

A63. The system of embodiment A62, wherein the first and second value associated with the PPI icing avoidance value are used to determine the PPI icing avoidance value.

A64. A dynamic AIC flight planning system, comprising: means to receive parameter data for an initial anticipated flight plan; means to determine airfoil type for an aircraft associated with the initial anticipated flight plan; means to obtain atmospheric data based on the flight plan parameter data; means to determine a plurality of grid points based on the flight plan parameter data; means to determine corresponding icing data for each grid point of the plurality of grid points based on the airfoil type and atmospheric data; and means to determine a percent power increase for the initial anticipated flight plan.

A65. The system of embodiment A64, further comprising means to output the determined percent power increase.

A66. The system of embodiment A64 or A65, further comprising means to determine an at least one alternative flight plan.

A67. The system of embodiment A66, further comprising means to determine a percent power increase for the at least one alternative flight plan.

A68. The system of embodiment A67, further comprising means to output the determined percent power increase for the at least one alternative flight plan.

A69. The system of embodiment A67, further comprising means to compare the initial anticipated flight plan and the at least one alternative flight plan.

A70. The system of embodiment A69, wherein the comparison is based on determined percent power increase.

A71. The system of embodiment A69 or A70, wherein the comparison is based on distance.

A72. The system of any of embodiments A69-A71, wherein the comparison is based on flight time.

A73. The system of any of embodiments A69-A72, wherein the comparison is based on fuel consumption.

A74. The system of any of embodiments A69-A73, wherein the comparison is based on risk.

A75. The system of any of embodiments A66-A73, further comprising means to determine at least one alternative flight plan based on the flight plan parameter data and the determined percent power increase for the initial anticipated flight plan.

A76. The system of any of embodiments A66-A75, further comprising means to provide the determined at least one alternative flight plan.

A77. The system of any of embodiments A64-A76, wherein the grid points are four-dimensional grid points.

A78. The system of any of embodiments A64-A77, wherein the parameter data includes aircraft data.

A79. The system of any of embodiments A64-A78, wherein the parameter data includes the airfoil type.

A80. The system of any of embodiments A64-A79, wherein the initial anticipated flight plan comprises a shortest route flight plan.

A81. The system of any of embodiments A66-A80, wherein the at least one alternative flight plan comprises an optimized route flight plan.

A82. The system of embodiment A81, wherein the optimized route flight plan is optimized for safety.

A83. The system of embodiment A81 or A82, wherein the optimized route flight plan is optimized fuel consumption.

A84. The system of any of embodiments A64-A83, wherein the flight plan parameter data includes take-off time.

A85. The system of any of embodiments A64-A84, wherein the flight plan parameter data includes take-off location.

A86. The system of any of embodiments A64-A85, wherein the flight plan parameter data includes destination location.

### AIC Controller

FIG. 16 shows a block diagram illustrating embodiments of an AIC controller 1601. In this embodiment, the AIC controller 1601 may serve to aggregate, process, store, search, serve, identify, instruct, generate, match, and/or facilitate interactions with a computer through various technologies, and/or other related data.

Typically, users, e.g., 1633a, which may be people and/or other systems, may engage information technology systems (e.g., computers) to facilitate information processing. In turn, computers employ processors to process information; such processors 1603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the AIC controller 1601 may be connected to and/or communicate with entities such as, but not limited to: one or more users from user input devices 1611; peripheral devices 1612; an optional cryptographic processor device 1628; and/or a communications network 1613. For example, the AIC controller 1601 may be connected to and/or communicate with users, e.g., 1633a, operating client device(s), e.g., 1633b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The AIC controller 1601 may be based on computer systems that may comprise, but are not limited to, components such as: a computer systemization 1602 connected to memory 1629.

### Computer Systemization

A computer systemization 1602 may comprise a clock 1630, central processing unit (“CPU(s)” and/or “processor(s)” (these terms are used interchangeable throughout the disclosure unless noted to the contrary)) 1603, a memory 1629 (e.g., a read only memory (ROM) 1606, a random access memory (RAM) 1605, etc.), and/or an interface bus 1607, and most frequently, although not necessarily, are all interconnected and/or communicating through a system bus 1604 on one or more (mother)board(s) 1602 having conductive and/or otherwise transportive circuit pathways through which instructions (e.g., binary encoded signals) may travel to effectuate communications, operations, storage, etc. The computer systemization may be connected to a power source 1686; e.g., optionally the power source may be internal. Optionally, a cryptographic processor 1626 and/or transceivers (e.g., ICs) 1674 may be connected to the system bus. In another embodiment, the cryptographic processor and/or transceivers may be connected as either internal and/or external peripheral devices 1612 via the interface bus I/O. In turn, the transceivers may be connected to antenna(s) 1675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing AIC controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the AIC controller and beyond through various interfaces. Should processing requirements dictate a greater amount speed and/or capacity, distributed processors (e.g., Distributed AIC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the AIC may be achieved by implementing a microcontroller such as CAST's R8051XC2 microcontroller; Intel's MCS 51 (i.e., 8051 microcontroller); and/or the like. Also, to implement certain features of the AIC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the AIC component collection (distributed or otherwise) and/or features may be implemented via the microprocessor and/or via embedded components; e.g., via ASIC, coprocessor, DSP, FPGA, and/or the like. Alternately, some implementations of the AIC may be implemented with embedded components that are configured and used to achieve a variety of features or signal processing. An example AIC component (e.g., PPI Component 1649) substantially in the form of a field-programmable gate array configured as an integrated circuit for performing the features of the PPI component may be found with respect to FIGS. 15A-F. It should be appreciated that the example PPI hardware component disclosed is provided to enhance the reader's understanding of the instant disclosure and is but one embodiment of the AIC disclosed herein. Furthermore, as substantially all integrated circuits may be represented as one or more alternative integrated circuits, hardware description language statements (e.g., VHDL, Verilog, and/or the like), programming language commands, and/or the like, embodiments of the disclosed PPI hardware component represented as alternative hardware designs and/or software or software/hardware combinations are possible based on this disclosure.

Depending on the particular implementation, the embedded components may include software solutions, hardware solutions, and/or some combination of both hardware/software solutions. For example, AIC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the AIC features. A hierarchy of programmable interconnects allow logic blocks to be interconnected as needed by the AIC system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the AIC may be developed on regular FPGAs and then migrated into a fixed version that more resembles ASIC implementations. Alternate or coordinating implementations may migrate AIC controller features to a final ASIC instead of or in addition to FPGAs. Depending on the implementation all of the aforementioned embedded components and microprocessors may be considered the “CPU” and/or “processor” for the AIC.

### Power Source

The power source 1686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1686 is connected to at least one of the interconnected subsequent components of the AIC thereby providing an electric current to all subsequent components. In one example, the power source 1686 is connected to the system bus component 1604. In an alternative embodiment, an outside power source 1686 is provided through a connection across the I/O 1608 interface. For example, a USB and/or IEEE 1394 connection carries both data and power across the connection and is therefore a suitable source of power.

### Interface Adapters

Interface bus(ses) 1607 may accept, connect, and/or communicate to a number of interface adapters, conventionally although not necessarily in the form of adapter cards, such as but not limited to: input output interfaces (I/O) 1608, storage interfaces 1609, network interfaces 1610, and/or the like. Optionally, cryptographic processor interfaces 1627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1609 may accept, communicate, and/or connect to a number of storage devices such as, but not limited to: storage devices 1614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1610 may accept, communicate, and/or connect to a communications network 1613. Through a communications network 1613, the AIC controller is accessible through remote clients 1633b (e.g., computers with web browsers) by users 1633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed AIC), architectures may similarly be employed to pool, load balance, and/or otherwise increase the communicative bandwidth required by the AIC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1610 may be used to engage with various communications network types 1613. For example, multiple network interfaces may be employed to allow for the communication over broadcast, multicast, and/or unicast networks.

Input Output interfaces (I/O) 1608 may accept, communicate, and/or connect to user input devices 1611, peripheral devices 1612, cryptographic processor devices 1628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1611 often are a type of peripheral device 1612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1612 may be connected and/or communicate to I/O and/or other facilities of the like such as network interfaces, storage interfaces, directly to the interface bus, system bus, the CPU, and/or the like. Peripheral devices may be external, internal and/or part of the AIC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 1628), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the AIC controller may be embodied as an embedded, dedicated, and/or monitor-less (i.e., headless) device, wherein access would be provided over a network interface connection.

Cryptographic units such as, but not limited to, microcontrollers, processors 1626, interfaces 1627, and/or devices 1628 may be attached, and/or communicate with the AIC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1629. However, memory is a fungible technology and resource, thus, any number of memory embodiments may be employed in lieu of or in concert with one another. It is to be understood that the AIC controller and/or a computer systemization may employ various forms of memory 1629. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1629 will include ROM 1606, RAM 1605, and a storage device 1614. A storage device 1614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1629 may contain a collection of program and/or database components and/or data such as, but not limited to: operating system component(s) 1615 (operating system); information server component(s) 1616 (information server); user interface component(s) 1617 (user interface); Web browser component(s) 1618 (Web browser); database(s) 1619; mail server component(s) 1621; mail client component(s) 1622; cryptographic server component(s) 1620 (cryptographic server); the AIC component(s) 1635; and/or the like (i.e., collectively a component collection). These components may be stored and accessed from the storage devices and/or from storage devices accessible through an interface bus. Although non-conventional program components such as those in the component collection, typically, are stored in a local storage device 1614, they may also be loaded and/or stored in memory such as: peripheral devices, RAM, remote storage facilities through a communications network, ROM, various forms of memory, and/or the like.

### Operating System

The operating system component 1615 is an executable program component facilitating the operation of the AIC controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NTNista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the AIC controller to communicate with other entities through a communications network 1613. Various communication protocols may be used by the AIC controller as a subcarrier transport mechanism for interaction, such as, but not limited to: multicast, TCP/IP, UDP, unicast, and/or the like.

### Information Server

An information server component 1616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the AIC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the AIC database 1619, operating systems, other program components, user interfaces, Web browsers, and/or the like.

Access to the AIC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the AIC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the AIC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XPNista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the AIC enabled nodes. The combined application may be nugatory on systems employing standard Web browsers.

### Mail Server

A mail server component 1621 is a stored program component that is executed by a CPU 1603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the AIC.

Access to the AIC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1622 is a stored program component that is executed by a CPU 1603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1620 is a stored program component that is executed by a CPU 1603, cryptographic processor 1626, cryptographic processor interface 1627, cryptographic processor device 1628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the AIC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the AIC component to engage in secure transactions if so desired. The cryptographic component facilitates the secure accessing of resources on the AIC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The AIC Database

The AIC database component 1619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the AIC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the AIC database is implemented as a data-structure, the use of the AIC database 1619 may be integrated into another component such as the AIC component 1635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1619 includes several tables 1619a-1. A User table 1619a may include fields such as, but not limited to: user_id, ssn, dob, first_name, last_name, age, state, address_firstline, address_secondline, zipcode, devices_list, contact_info, contact_type, alt_contact_info, alt_contact_type, user_equipment, user_plane, user_profile, and/or the like. An Account table 1619b may include fields such as, but not limited to: acct_id, acct_user, acct_history, acct_access, acct_status, acct_subscription, acct_profile, and/or the like.

A Profile table 1619c may include fields such as, but not limited to: prof_id, prof_assets, prof_history, prof_details, profile_aircraft, and/or the like. A Terrain table 1619d may include fields such as, but not limited to: terrain_id, terrain_details, terrain_parameters, terrain_var, and/or the like. A Resource table 1619e may include fields such as, but not limited to: resource_id, resource_location, resource_acct, and/or the like. An Equipment table 1619f may include fields such as, but not limited to: equip_id, equip_location, equip_acct, equip_contact, equip_type, and/or the like. A Model table 1619g may include fields such as, but not limited to: model_id, model_assc, model_PPI, model_feedback, model_param, model_var, and/or the like. A Weather data table 1619h may include fields such as, but not limited to: weather_data_id, weather_source, weather_location, weather_data_type, weather_acct, weather_icing, weather_var, and/or the like. In one embodiment, the weather data table is populated through one or more weather data feeds. A Feedback table 1619i may include fields such as, but not limited to: feedback_id, feedback_source, source_location, feedback_time, feedback_acct, and/or the like.

An Aircraft table 1619j may include fields such as, but not limited to: aircraft_id, aircraft_type, aircraft_profile, aircraft_fuel_capacity, aircraft_route, aircraft_use, aircraft_owner, aircraft_location, aircraft_acct, aircraft_flightplan, aircraft_parameters, aircraft_airfoil, aircraft_alerts, and/or the like. A Flight Plan table 1619k may include fields such as, but not limited to: flightplan_id, flightplan_source, flightplan_start_location, flightplan_start_time, flightplan_end_location, flightplan_end_time, flightplan_acct, flightplan_aircraft, flightplan_profile, flightplan_type, flightplan_alerts, flightplan_parameters, flightplan_airfoil, flightplan_PPI and/or the like. An Airfoil table 16191 may include fields such as, but not limited to: airfoil_id, airfoil_source, airfoil_aircraft, airfoil_icing_profile, airfoil_icing_determination, airfoil_profile, airfoil_type, airfoil_pi, airfoil_alerts, airfoil_parameters, airfoil_PPI, and/or the like.

In one embodiment, the AIC database may interact with other database systems. For example, employing a distributed database system, queries and data access by search AIC component may treat the combination of the AIC database, an integrated data security layer database as a single database entity.

In one embodiment, user programs may contain various user interface primitives, which may serve to update the AIC. Also, various accounts may require custom database tables depending upon the environments and the types of clients the AIC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1619a-1. The AIC may be configured to keep track of various settings, inputs, and parameters via database controllers.

The AICAIC database may communicate to and/or with other components in a component collection, including itself, and/or facilities of the like. Most frequently, the AIC database communicates with the AIC component, other program components, and/or the like. The database may contain, retain, and provide information regarding other nodes and data.

### The AICs

The AIC component 1635 is a stored program component that is executed by a CPU. In one embodiment, the AIC component incorporates any and/or all combinations of the aspects of the AIC discussed in the previous figures. As such, the AIC affects accessing, obtaining and the provision of information, services, transactions, and/or the like across various communications networks. The features and embodiments of the AIC discussed herein increase network efficiency by reducing data transfer requirements by the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the AIC's features and facilities, and in many cases reduce the costs, energy consumption/requirements, and extend the life of AIC's underlying infrastructure; this has the added benefit of making the AIC more reliable. Similarly, many of the features and mechanisms are designed to be easier for users to use and access, thereby broadening the audience that may enjoy/employ and exploit the feature sets of the AIC; such ease of use also helps to increase the reliability of the AIC. In addition, the feature sets include heightened security as noted via the Cryptographic components 1620, 1626, 1628 and throughout, making access to the features and data more reliable and secure. Additionally, the AIC enables more efficient and safe flight planning and routing, including real-time dynamic responsiveness to changing weather conditions.

The AIC component may transform weather data input via AIC components into real-time and/or predictive icing feeds and displays, and/or the like and use of the AIC. In one embodiment, the AIC component 1635 takes inputs (e.g., weather forecast data, atmospheric data, models, sensor data, and/or the like) etc., and transforms the inputs via various components (a Tracking component 1644; a Pathing component 1645; a Display component 1646; an Alerting component 1647; a Planning component 1648; a PPI component 1649; an input component 1650; an icing component 1651; a CFD component 1652; a TdA component 1653; an NWF component 1654; and/or the like), into outputs (e.g., predictive flight path icing, percent power increase needed, real-time airfoil-specific icing data, flight path modifications/optimizations, icing alerts, and/or the like).

The AIC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the AIC server employs a cryptographic server to encrypt and decrypt communications. The AIC component may communicate to and/or with other components in a component collection, including itself, and/or facilities of the like. Most frequently, the AIC component communicates with the AIC database, operating systems, other program components, and/or the like. The AIC may contain, communicate, generate, obtain, and/or provide program component, system, user, and/or data communications, requests, and/or responses.

### Distributed AICs

The structure and/or operation of any of the AIC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the AIC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the AIC controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header (′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die (‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while ($ input != “”);
// parse data to extract variables
$obj = json_decode($data, true);
// store input data in a database
mysql_connect(″201.408.185.132″,$DBserver, $password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference herein.

In order to address various issues and advance the art, the entirety of this application for AIRFOIL ICING CONTROLLER APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a AIC individual and/or enterprise user, database configuration and/or relational model, data type, data transmission and/or network framework, syntax structure, and/or the like, various embodiments of the AIC may be implemented that enable a great deal of flexibility and customization. For example, aspects of the AIC may be adapted for integration with flight planning and route optimization. While various embodiments and discussions of the AIC have been directed to predictive icing, however, it is to be understood that the embodiments described herein may be readily configured and/or customized for a wide variety of other applications and/or implementations.

What is claimed is:

1. A dynamic airfoil icing controller flight planning system, comprising:
means to receive parameter data for an initial anticipated flight plan;
means to determine airfoil type for an aircraft associated with the initial anticipated flight plan;
means to obtain atmospheric data based on the flight plan parameter data;
means to determine a plurality of grid points based on the flight plan parameter data;
means to determine corresponding icing data for each grid point of the plurality of grid points based on the airfoil type and atmospheric data; and
means to determine a percent power increase for the initial anticipated flight plan.

2. The system of claim 1, further comprising:
means to output the determined percent power increase.

3. The system of any preceding claim, further comprising:
means to determine an at least one alternative flight plan.

4. The system of claim 3, further comprising:
means to determine a percent power increase for the at least one alternative flight plan.

5. The system of claim 4, further comprising:
means to output the determined percent power increase for the at least one alternative flight plan.

6. The system of claim 4, further comprising:
means to compare the initial anticipated flight plan and the at least one alternative flight plan.

7. The system of claim 6, wherein the comparison is based on determined percent power increase.

8. The system of claim 6 or 7, wherein the comparison is based on distance.

9. The system of any of claims 6-8, wherein the comparison is based on flight time.

10. The system of any of claims 6-9, wherein the comparison is based on fuel consumption.

11. The system of any of claims 6-10, wherein the comparison is based on risk.

12. The system of any of claims 3-11, further comprising:
means to determine at least one alternative flight plan based on the flight plan parameter data and the determined percent power increase for the initial anticipated flight plan.

13. The system of any of claims 3-12, further comprising:
means to provide the determined at least one alternative flight plan.

14. The system of any preceding claim, wherein the grid points are four-dimensional grid points.

15. The system of any preceding claim, wherein the parameter data includes aircraft data.

16. The system of any preceding claim, wherein the parameter data includes the airfoil type.

17. The system of any preceding claim, wherein the initial anticipated flight plan comprises a shortest route flight plan.

18. The system of any of claims 3-17, wherein the at least one alternative flight plan comprises an optimized route flight plan.

19. The system of claim 18, wherein the optimized route flight plan is optimized for safety.

20. The system of claim 18 or 19, wherein the optimized route flight plan is optimized fuel consumption.

21. The system of any preceding claim, wherein the flight plan parameter data includes take-off time.

22. The system of any preceding claim, wherein the flight plan parameter data includes take-off location.

23. The system of any preceding claim, wherein the flight plan parameter data includes destination location.

24. A dynamic airfoil icing controller processor-implemented flight planning method, comprising:
receiving parameter data for an initial anticipated flight plan;
determining airfoil type for an aircraft associated with the initial anticipated flight plan;
obtaining atmospheric data based on the flight plan parameter data;
determining a plurality of four-dimensional grid points based on the flight plan parameter data;
determining corresponding icing data for each point of the plurality of four-dimensional grid point based on the airfoil type;
determining via a processor a percent power increase for the initial anticipated flight plan;
determining an at least one alternative flight plan based on the flight plan parameter data and the determined percent power increase for the initial anticipated flight plan; and
providing the determined at least one alternative flight plan.

25. The method of claim 24, wherein the parameter data includes at least one of aircraft data and airfoil type.

26. The method of claim 24, wherein the initial anticipated flight plan comprises a shortest route flight plan.

27. The method of any of claims 24-26, wherein the at least one alternative flight plan comprises an optimized route flight plan.

28. The method of claim 27, wherein the optimized route flight plan is optimized for safety.

29. The method of claim 27, wherein the optimized route flight plan is optimized for safety and fuel consumption.

30. The method of any of claims 24-29, wherein the flight plan parameter data includes at least one of flight take-off time, flight take-off location, flight destination location, and anticipated flight destination location arrival time.

31. A dynamic airfoil icing controller flight planning apparatus, comprising:
a processor; and
a memory disposed in communication with the processor and storing processor-issuable instructions to perform the method of any of claims 24-30.

32. A processor-readable tangible medium storing processor-issuable dynamic airfoil icing controller flight plan generating instructions to perform the method of any of claims 24-30.
